(19) United States
(12) Patent Application Publication
(10) Pub. No.: US 2002/0065882 A1
(43) Pub. Date: May 30, 2002

(54) System and method for creating administering joining and participating in event pools

(76) Inventors: Howard Arkin, Wayne, NJ (US); Heinz Huber, Stroudsburg, PA (US)

Correspondence Address: WHITE & CASE LLP, PATENT DEPARTMENT, 1155 AVENUE OF THE AMERICAS, NEW YORK, NY, 10036, US

(21) Appl. No.: 09/727,821

(22) Filed: Nov. 30, 2000

(51) Int. Cl. G06F 15/16

(52) U.S. Cl. 709/204

(57) ABSTRACT

The invention provides a network or internet-based system which enables administrators, participants, clients, third parties, and other users to construct and employ customizable and private label pools relating to well known and personal events, preferably, in a world wide web site environment providing private label capabilities to advertisers or other users.

The present invention relates to a network or internet-based system which provides pool administration services. In particular, the invention concerns a network or internet-based system which enables administrators, participants, clients, third parties, and other users to construct and employ customizable and private label pools relating to well known and personal events, preferably, in a world wide web site environment providing private label capabilities to advertisers or other users.

### BACKGROUND OF THE INVENTION

The outcome of both well known and personal events is of great interest to those closely involved with the event as well as those who merely observe. For example, the winner, best time, or final score of a sporting event is important to participants and fans alike. Observers often monitor and keep track of such scores or times and even record the results in databases or the like for further comparison and study. The results and selections for many sporting and similar events are also widely circulated in print, electronic, and other media and in some circumstances are the lead or top story in such media. For some events, groups of people interested in the outcome create and join a pool, i.e., they get together and consolidate their resources, agree to certain rules and parameters for a contest or game based on the outcome of the event, make and keep track of their outcome predictions, or picks, prior to the event, and take steps to reward those players whose picks are the closest to the actual outcome, for example, by awarding prizes or points based on correct picks. Each of these actions is often time-intensive and tedious, chiefly because each necessarily requires significant cooperation and interaction between many people. The pool administrator, i.e., the person in charge of developing, updating, and maintaining the pool, spends innumerable hours regulating, collecting, and checking and re-checking picks and resources. These problems are compounded when the number of participants or the number of possible results in the event increases greatly, as with the more popular sporting events, such as the Super Bowl® and the NCAA® men's college basketball tournament.

Several systems have been developed for facilitating the functions and activities pool administrators and participants must perform. Perhaps the most common of such systems is the traditional computer software based pool administration system, which typically utilizes a computer program that contains a database of picks. The traditional software database system typically includes a computer program loaded onto a stand alone computer and allows a pool administrator to input a large number of participants' picks into a database maintained by the program which reports the leaders and winners after each round of the event and at the conclusion of the event.

A disadvantage of such computer software systems, however, is that these systems aid in only one of many steps which the administrator must perform; that step being checking the participants' picks after each round or at the end of the event. Even using a computer software system, the administrator must distribute pool information to each participant, input each participant's picks, update the program after each relevant round or event, and relay the standings to each participant at the end of each round or event. Each of the steps taken by the administrator is often time-consuming and frustrating. For example, waiting for each participant to send in picks by a deadline involves great patience and typically includes receiving many late entries and unhappy would-be participants. Moreover, manually entering each pick on the part of the administrator often results in mistakes by the administrator which may result in an incorrect leader board or winner of the pool.

Another disadvantage of such computer software pool administration systems is that these systems do not allow direct participant review or access to pool information without contact from the administrator. Participants must rely on the administrator for updates and listings of leaders or winners and participants typically cannot check the standings of the pool, review other participants' picks and the date other participants' picks were submitted, or check the spread used by the administrator, i.e., the weighted point differential, if any, at any time prior to, during, or after the event. This is especially true where the software-based system is installed on only one computer accessible by only the pool administrator or administrators.

Another disadvantage of computer software pool administration systems is that such systems do not incorporate a deadline by which each participant's picks must be entered nor do they permit the participant to change picks after the initial entry but prior to any pick cut-off date.

Another disadvantage of computer software pool administration systems is that such systems typically must be purchased and take time to install and operate correctly. The administrator must also abide by the choices made by the software programmer in deciding the pool type and the pool parameters. For example, if an event has several rounds, such as a tennis or basketball tournament, the administrator is limited to the round values programmed into the software; correct picks in the earlier rounds typically being lower in value than correct picks in later rounds or the final round. Moreover, the administrator of a software-based system cannot typically re-program the software to create new pools. For example, if a software-based pool administration system includes a software program for a standard bracket-type pool, such as typically used in a basketball tournament, the administrator cannot re-program the software to include a non-bracket pool. Nor may the administrator add to the program side pools based on events within the main event.

Because the software-based systems are typically embodied in a single, stand-alone computer program, such systems have the added disadvantage of not being connected to or having access to real time updates or scoring, such as, for example, by being connected or linked to internet-based news and sports information sites and real time sources. Such software-based systems also cannot take advantage of the various advertising, marketing, and shopping tools available on the internet and internet-based platforms, which make available innumerable opportunities to present valuable information to users by, for example, linking the user sites to sites related to the event upon which the pool is based, i.e., the pool event, or like events or other material that may be of interest to pool participants.

What is desired, therefore, is a system and method for administering event pools which will simplify each action, function or step performed by pool administrators and participants in creating, maintaining, and joining pools and further provide access to related information, such as real time scores and scoring, information, related advertising and the like. Providing a system in which the administrator may customize pool types and rules and create unique pools related to personal events is also desired, as is a system in which the participants/members/players have direct access to up-to-date pool information. A system and method that enables administrators and others to incorporate or link or otherwise include related or non-related advertising, marketing and shopping into the system is also desired as is the ability of a programmer, user, or programming partner to create and administer a private label type pool, in which the pool appears to be sponsored and run by an advertiser or sponsor and not the programmer.

### SUMMARY OF THE INVENTION

Accordingly, it is an object of the present invention to provide a system and method for use by those interested in the outcome of certain events which simplifies, improves and customizes the administration and participation in event pools.

Another object of the invention is to provide a system and method of the above character that is network-based and thereby accessible to multiple users generally and simultaneously. Such a system obviates the typical distribution, input, update, and relay activities required of a pool administrator in a traditional system.

Another object of the invention is to provide a system and method of the above character that is internet-based and thus accessible to multiple users generally and simultaneously. Such a system further obviates the typical distribution, input, update, and relay activities required of a pool administrator in a traditional system.

Another object of the present invention is a system and method of administering event pools that includes a device or step that sets date and time limits for the user to enter and/or change pool pick entries and a user's ability to view other users' picks, particularly to allow a user to view standings and other pool information before, during, and after the event.

Another object of the present invention is a system and method wherein some or all of the pools are customizable, that is, such that the administrator may decide certain parameters, such as round values or points, and rules for each pool so that, for example, particular rounds or sub-events in multiple pools for the same event will not necessarily be scored the same way. In this way, each administrator may change the default settings for certain parameters or sub-events when creating a pool. The customizable aspect of the system and method of the invention also pertains to an administrator's ability to create a known pool type for a private event, such as a baby pool for an upcoming birth.

Another object of the present invention is a system and method wherein the pools are customized for particular third party clients such that the administrator may collaborate with the client to incorporate any specific rules or parameters into each customized client related pool and, in addition, customize the design and content of the pool network or web pages to include pool related links or advertisements. In this way, the administrator may also collaborate with the client to design, for example, customized user membership information or demographic pages to enable the client to collect membership information for each game or pool useful for market evaluation and advertising.

Another object of the present invention is a system and method wherein a user or consumer may participate or join pre-fabricated pools, i.e., pools that are created and administered by a programmer or web site manager.

Another object of the present invention is a system and method wherein a programmer, user, or programming partner may customize the network or web page screens a pool participant will see, for example, by incorporating a multi-hierarchical structure in a customized screen. Such structure would allow for customization and changeability of network or web pages, which, for example, would allow a programmer, user, or programming partner to employ and assign various levels of advertising, information, and links to screen areas of differing sizes within network or web pages. Such a system or method would allow a program partner or other user to customize pool the pages such that the pages appear to be sponsored by the user or program partner and not the site provider or programmer.

These and other objects of the invention are achieved by provision of a network- or internet-based system for administering event pools. The system includes a network site coupled with a programmer point and a user network point. The programmer point includes a computer terminal or other precise interface that enables a programmer to provide information to the network site and stores user information provided by a user at the user network point. The user network point includes a network-connected computer terminal that provides user access to the network site and allows a user to provide user information to the programmer point. The network site of the system also includes a network site page that enables a user to create or join an event pool based on network site and user information The network or web site of the system enables the pool creator or administrator to customize a pool by defining and changing pool type, rules, and parameters and assigning a unique name and password to the pool. The programmer point includes one or more databases for storing user information provided by a user at the user network or internet point. Preferably, the programmer point includes at least a membership database for storing and tracking membership and membership related user information and a transactional database for storing and tracking user and member involved pools and picks and other related information.

In another aspect of the invention, the network or web site of the system also includes a customizable network site or web page that may be designed and changed by a user or a programmer. Such a network site or web page enables a programmer or user to incorporate advertising and other pool or non-pool related information or, in the case of a web page, internet links, into the network or web page. In another embodiment, the customizable network or web page comprises a multi-hierarchical structure of a customized screen. Such structure enables a programmer or user to, among other things, customize and alter the structure and changeability of the page to incorporate, for example, private label type advertising or sponsorship of a pool for advertisers or programming partners, and pool or non-pool related information, such as sports scores and news.

The invention and its particular features and advantages will become more apparent from the following detailed description considered with reference to the accompanying drawings.

### BRIEF DESCRIPTION OF THE DRAWINGS

FIG. 1 is a diagram of a system and method for administering event pools in accordance with the invention.

FIG. 2 shows a bracket pool utilized by the present invention.

FIG. 3 shows a box or grid pool utilized by the present invention.

FIG. 4 shows a web site home page in accordance with the present invention.

FIG. 5 shows a new player web page in accordance with the present invention.

FIG. 6 shows a web page which allows a new player to join an existing pool in accordance with the present invention.

FIG. 7 shows a web page, entitled “New Pool Setup”, which allows a new player to create a new pool in accordance with the present invention.

FIG. 8 shows a web page indicating Step 1 of the new pool setup, agreeing to the terms of the pool guidelines, in accordance with the present invention.

FIG. 9 shows a web page indicating Step 2 of the new pool setup, naming the new pool and giving it a password, in accordance with the present invention.

FIG. 10 shows a confirmation web page indicating the Pool ID, Pool Name, and Pool Password for the newly created pool, in accordance with the present invention.

FIG. 11 shows a web page indicating Step 3 of the new pool setup, filling out the rules for the new pool, in accordance with the present invention.

FIG. 12 shows a web page indicating Step 3 of the new pool setup, filling out the rules for the new pool, in accordance with the present invention.

FIG. 13 shows a web page indicating Step 3 of the new pool setup, filling out the rules for the new pool, in accordance with the present invention.

FIG. 14 shows a web page indicating Step 3 of the new pool setup, filling out the rules for the new pool, in accordance with the present invention.

FIG. 15 shows a web page indicating Step 3 of the new pool setup, filling out the rules for the new pool, in accordance with the present invention.

FIG. 16 shows a web page indicating Step 3 of the new pool setup, filling out the rules for the new pool, in accordance with the present invention.

FIG. 17 shows a web page displaying the rules and settings for the new event pool, in accordance with the present invention.

FIG. 18 shows a web page indicating that a new pool has been successfully set up/created and allows a user to start playing in the pool, in accordance with the present invention.

FIG. 19 shows a web pool page allowing a user to make and view picks, view pool results and rules, and access other pools, in accordance with the present invention. The pool page also includes a pool topic area which allows a user to access and post new topic notes posted to the pool page in accordance with the present invention.

FIG. 20 shows a web page where a user may make event pool picks in accordance with the present invention.

FIG. 21 shows a web page where a user may view already made event pool picks in accordance with the present invention.

FIG. 22 shows a web page where a user may choose to view already made event pool picks or pool players sorted alphabetically or by high score, in accordance with the present invention.

FIG. 23 shows a personalized pool web page depicting advertising space and banners, in accordance with the present invention.

FIG. 24 shows baby pool utilized by the present invention.

FIG. 25 shows a multi-dimensional polling pool utilized by the present invention.

FIG. 26 shows a results page of a cumulative pool utilized by the present invention.

FIG. 27 shows a results page of a cumulative pool utilized by the present invention.

### DETAILED DESCRIPTION OF A PREFERRED EMBODIMENT

### System Set-Up

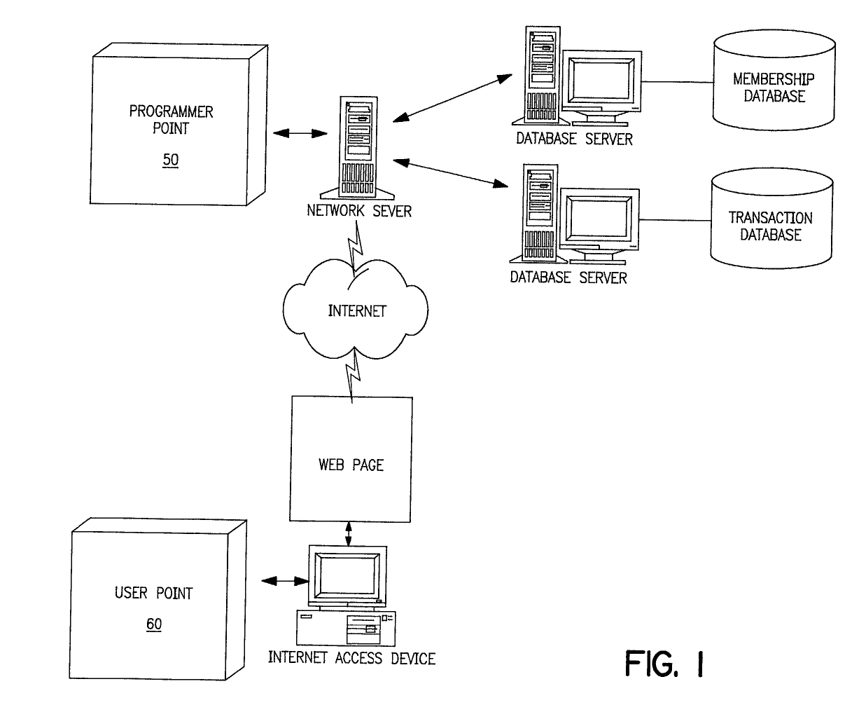

FIG. 1 depicts an internet-based system for administering event pools in accordance with the invention. A web site 40 is coupled with a programmer point 50 and a user internet point 60. A programmer utilizing the programmer point 50 provides web site information, such as public event names, through the programmer point 50 to the web site 40. A user utilizing the user internet point 60 accesses the web site 40 and is prompted to provide user membership information which, once provided and saved, is stored in a programmer point membership database 80. Web pages 70, utilizing both web site and user information, enable a user to create a new event pool or join an existing or prefabricated event pool. New pool and user pool information, such as pool type, administrator, rules, picks, points, and dates are stored in a programmer point transactional database 90.

The system of the invention is contemplated to include a user internet point 60 of a traditional type, i.e., a home or work computer, as well as a so-called “Internet kiosk” or “eOSK”, which is a stand alone e-commerce enabled internet terminal typically placed in a high-traffic public place for use by users or consumers.

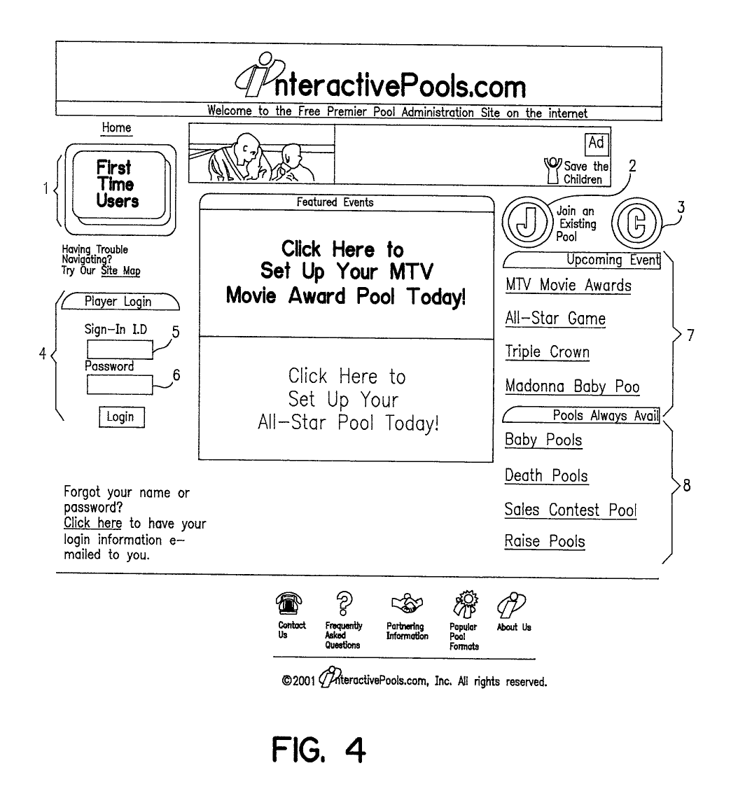

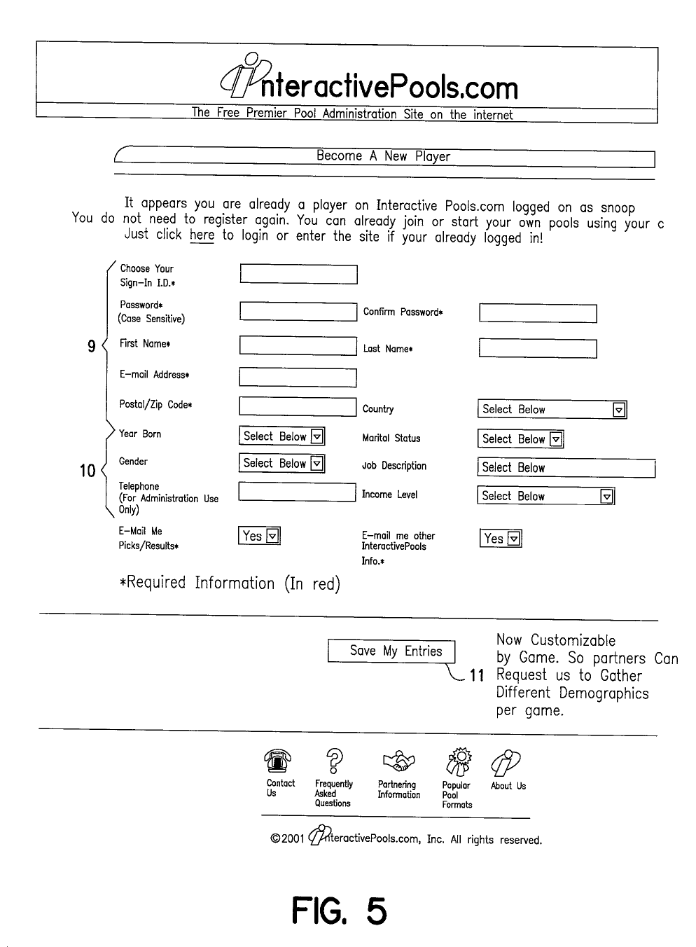

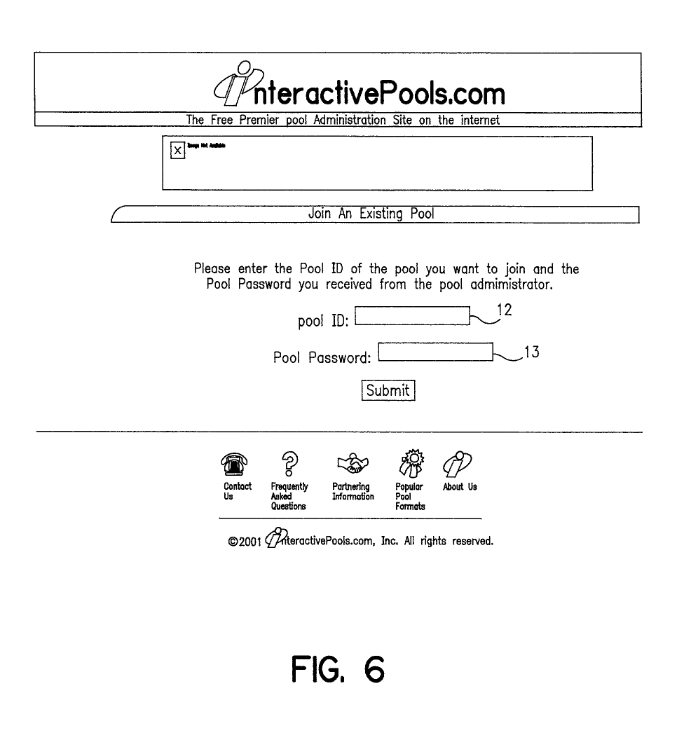

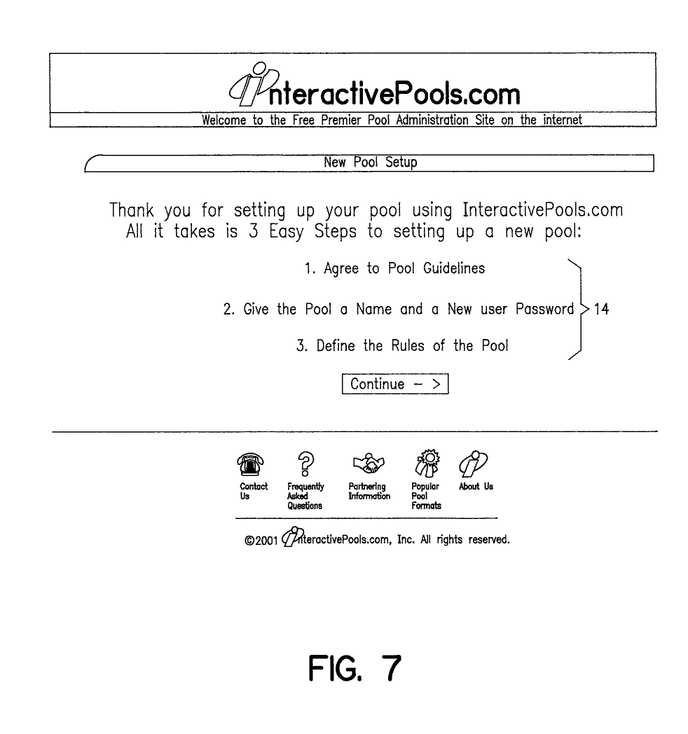

The web site home page depicted in FIG. 4 displays web site information and provides links to various web pages within the web site and displays login and other areas. The link entitled “First Time Users” 1 links to a web page as depicted in FIG. 5 which allows a user to sign up and become a new player. The large capital “J” link 2 links the home page to a web page as depicted in FIG. 6 which allows a member to join an existing pool. The large capital “C” 3 links the home page to a web page as depicted in FIG. 7 which allows a member to create a new pool. The “Player Login” area 4 includes a “Sign-In I.D.” box 5 and a “Password” box 6 which enables a player to sign in to the web site. The “Upcoming Events” area 7 indicates upcoming event pool events and provides links to customizable pools related to those events. The “Pools Always Available” area 8 indicates pools that are always available and provides links to customizable pools related to events of those types.

As depicted in FIG. 5, the web site collects certain biographical or demographic data on site users when users sign up with the web site as a new player. The web site collects user information, such as name, desired password and sign-in i.d., and e-mail address. This information remains in the user internet point until it is entered and saved by the user by clicking on the “Save My Entries” box 11 in the new player web page, FIG. 5. The user may also enter, but is not required to enter, additional information, such as age, gender, marital status, and job description. Where the present invention is implemented as a private-label or customized pool for a particular business customer, the business customer may advantageously customize the sign-in membership information collected from the user—referred to as “customizable registration.” For example, the business customer may be a particular radio station using a private label pool according to the present invention and seek the information regarding the user's listening habits in terms of radio. Alternatively, a particular business customer may want to limit the amount of information sought from the user though the sign-in process to avoid the appearance of intrusiveness.

Once entered, the user membership information is stored in the user membership database 80 at the programmer point 50. The programmer may use the user information stored in membership database 80 to develop a targeted advertising strategy or the like and also provides the programmer with demographic information that the programmer or site owner may use to promote or attract advertising sales, such as banner ads and the like. The programmer may also use the user information to allows a sponsor or other interested party connected with a particular pool to survey a user the pool with targeted questions—referred to as a “hierarchical questionnaire”—as described below.

### Creating a Pool & Pool Types

Once the user is registered as a player or member, he may create a pool, join a pool or access a number of different links from the home page, including advertiser's sites and other sports and news-related sites. When a member initiates actions to create a pool, he generally becomes its pool administrator. As described below, the pool administrator has a number of administrative capabilities not enjoyed by regular networks users. For example, the pool administrators select the type of pool, name the pool, distribute the name of the pool to the network users the pool administrator selects so only those users can enter and participated in the event pool. When joining an already existing pool, as depicted in FIG. 6, the player/member is required to enter the correct Pool ID and Pool Password, which were set by the pool administrator when creating the pool and subsequently communicated to players, in the corresponding boxes 12 and 13. The pool administrator also chooses the different parameters and options for the pool such as round values and closing dates.

In alternative embodiments described below, private-label pools and customized pools are also contemplated by the present invention. The present invention further contemplates pre-fabricated pools, i.e., pools created and administered by a programmer or web site manager, which users or members may join and participate in. Typically, no Pool ID or Pool Password is necessary in such pools, although a user sign-in ID may be required. The invention also includes a system having e-mail/join capabilities wherein each user when joining or creating a pool will submit their e-mail address and consent to e-mail notification of current or future pool events.

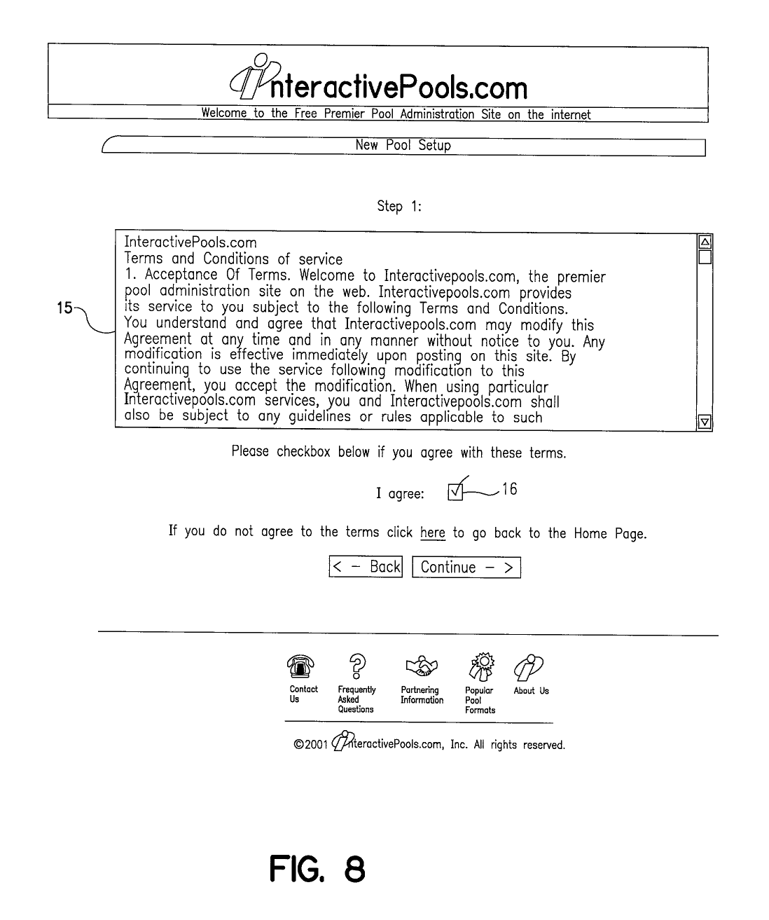

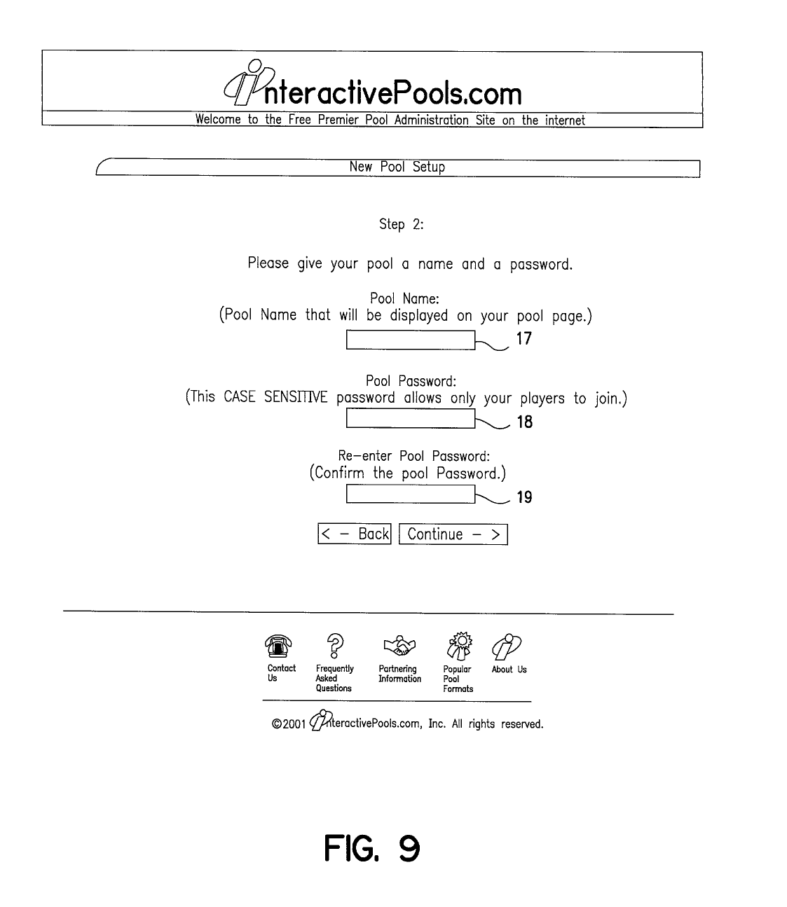

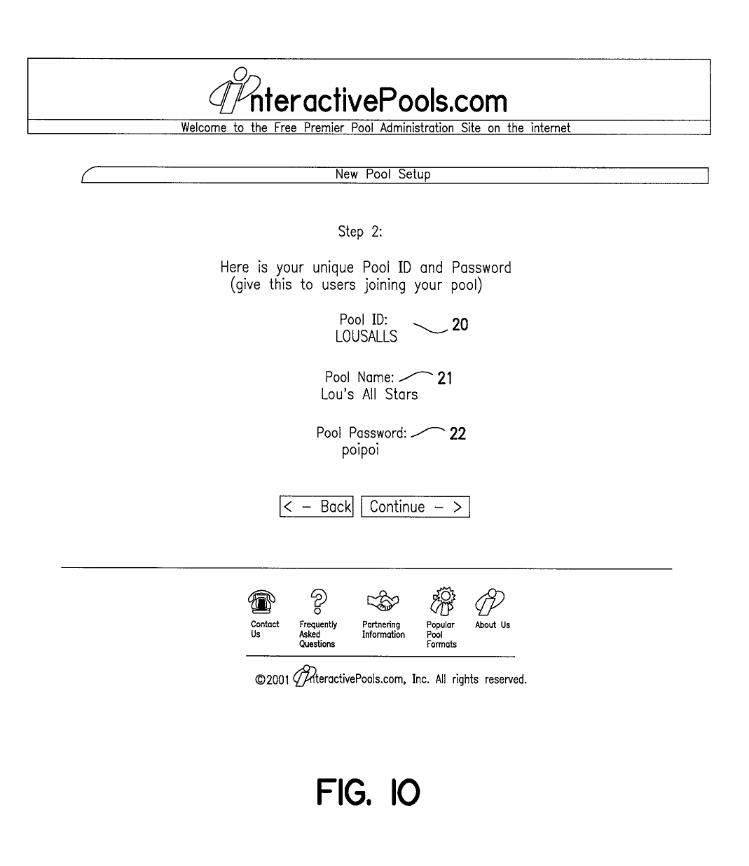

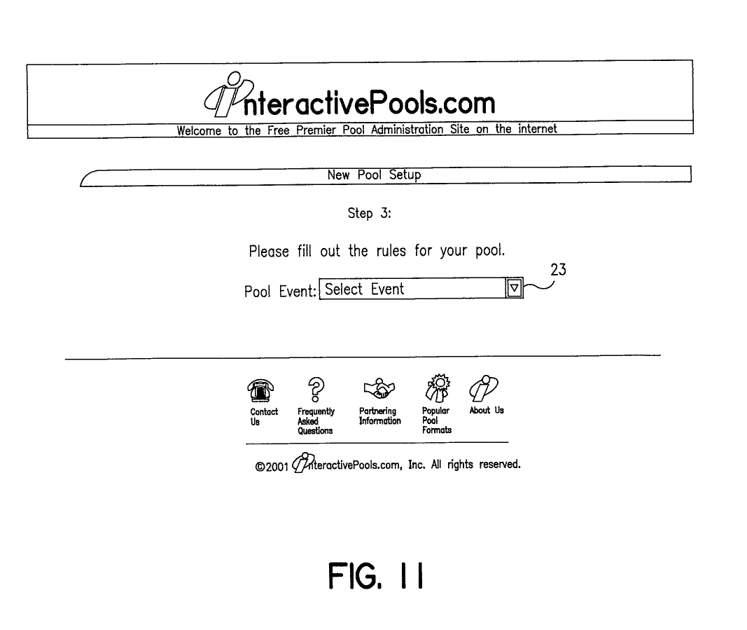

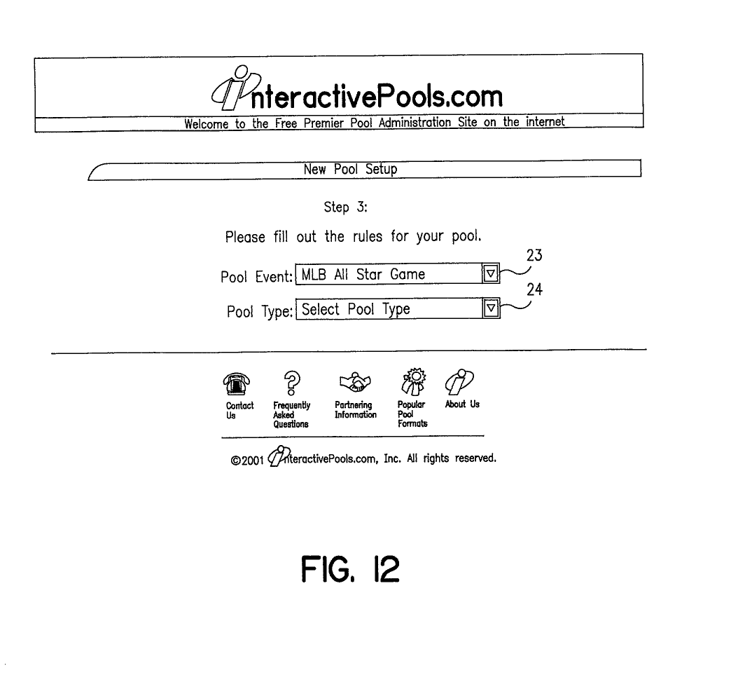

The system creates a new pool by prompting the pool administrator for information that is used to set up a pool. A user is guided through the steps to create a pool, which includes agreeing to pool guidelines, which may include standard limitation of liability agreements and the like, naming the pool and assigning it a unique identifier, and defining its rules and parameters. FIGS. 7-17 outlines the steps 14 to create a new pool in one embodiment of the present invention. Pool guidelines 15 are offered and an agreement box 16 is displayed. Subsequent to the new player agreeing to the pool guidelines, the player/administrator assigns a pool name and password, as indicated in FIG. 9, which shows two password boxes, a first password box 18 and a confirm password box 19. Pool name and password are important because once assigned the pool administrator will distribute, including via e-mail, these unique identifiers to players so that they may access and participate in the newly created pool. The present invention includes an “Auto Join” feature. The Auto Join feature emails a unique URL directly to identified-players. The URL allows the player to directly link to and participate in a pool without having to enter a password or pool name.

Once the unique identifiers have been assigned to a new pool, the administrator selects the event and pool type by drop down menu, as shown in FIG. 12, where the pool event box 23 and the select pool type box 24 are offered for choosing. The pool event offerings typically comprise those events outlined in Upcoming Event area 7, and include noteworthy sporting and other events well known by the public. Alternatively, private events (e.g., birth delivery dates, dates of anticipated engagement) may also be the subject of pools.

The programming point 50 has a plurality of facilities (e.g., CPUs, memory elements, databases, communication devices, input/output devices) which allow the creation and administering of event pools in accordance with the invention. The programming point 50 includes a database of fundamental graphical objects. Each of the objects correspond to the different types of pools identified below. The programming point 50 uses objects to build customized pools. The programming point 50 receives a plurality of inputs from the network users to customize the pools. Using a rule-based system, the system builds customized pools from the plurality of inputs received from the network user and the object database.

Each event is unique in its outcomes as are the processes by which the outcomes are determined. Thus, certain events are usually associated with certain types of event pools. For example, in a basketball or other tournament, there are typically rounds of play with winners and losers in each round progressing toward quarter-, semi-, and final round games. A typical bracket type pool or the like is ideal for such a process because it is set up for the tournament outcome. In contrast, a box or grid type pool is typically used for single game events with changing scores, like a football game. Each event offered in the pool event box 23, has corresponding pool types offered in the select pool type box 24 consistent with this concept. A detailed description of possible pool types follows.

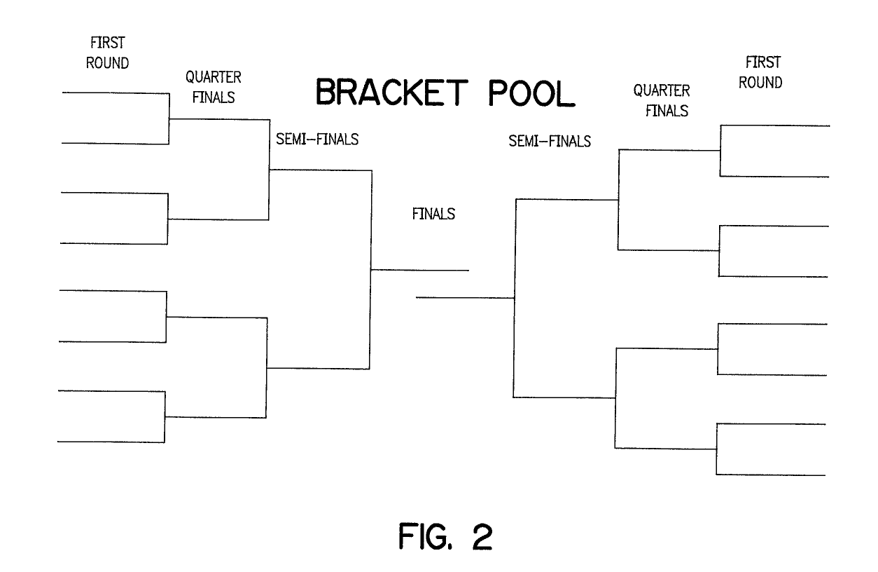

Different pool types offered by the system and method of the present invention include, but are not limited to, the bracket pool, flex bracket pool, the divorce pool, box or grid pool, cumulative pool, suicide pool, baby pool, death pool, awards pool, and power draft pool. The bracket pool, shown in FIG. 2, is the typical tournament pool, and includes an initial set up of first round contests with a winner who goes on to the next round and a loser who is out of the tournament, although this can be modified for a round robin type tournament. This process progresses to quarter-, semi-, and final round contests until the champion is decided in a final contest.

The flex bracket is substantially similar to the bracket pool described in connection with FIG. 2. It has the bracket format except it inserts later round opponents based on rankings not merely on the bracket. For example, teams a, b, c, d, e, and f are ranked 1 through 6 respectively. If teams c and f play each other in a first round contest and teams d and e also play each other in a first round contest, the second round contest may depend on the winner of the c-f and d-e contests. For example, if the third ranked team, c, wins against the sixth ranked team, f, in the first round, then the winner of the other first round contest between the fourth and fifth ranked teams, d and e, which is thus the lowest ranked team remaining, plays the highest remaining seed, the first ranked team, a, in the second round, and the third ranked team, c, plays the second ranked team, b, in the second round. If, however, the sixth ranked team, f, wins against the third ranked team, c, in the first round, it is the lowest ranked team remaining and thus plays the highest ranked team remaining, first ranked team a, in the second round and the winner of the d-e contest plays second ranked team b in the second round. In this way, the opponents in the second round contest are unknown at the beginning of the tournament event and the bracket must “flex” depending on the outcomes of each first round contest. The flex bracket is typically used in playoff scenarios involving wild card teams, such as the NFL® and NHL® playoffs. Given the programmer points ability to keep track of live events in real time, the present invention allows for alteration of event pools (such as the flex pool) in real-time. Thus, as seedings or match-ups are announced which effect the configuration of an on-going event pool, the present invention advantageously includes the flexibility to adapt to the announcement, configuring or reconfiguring an event pool to take into account the announcement.

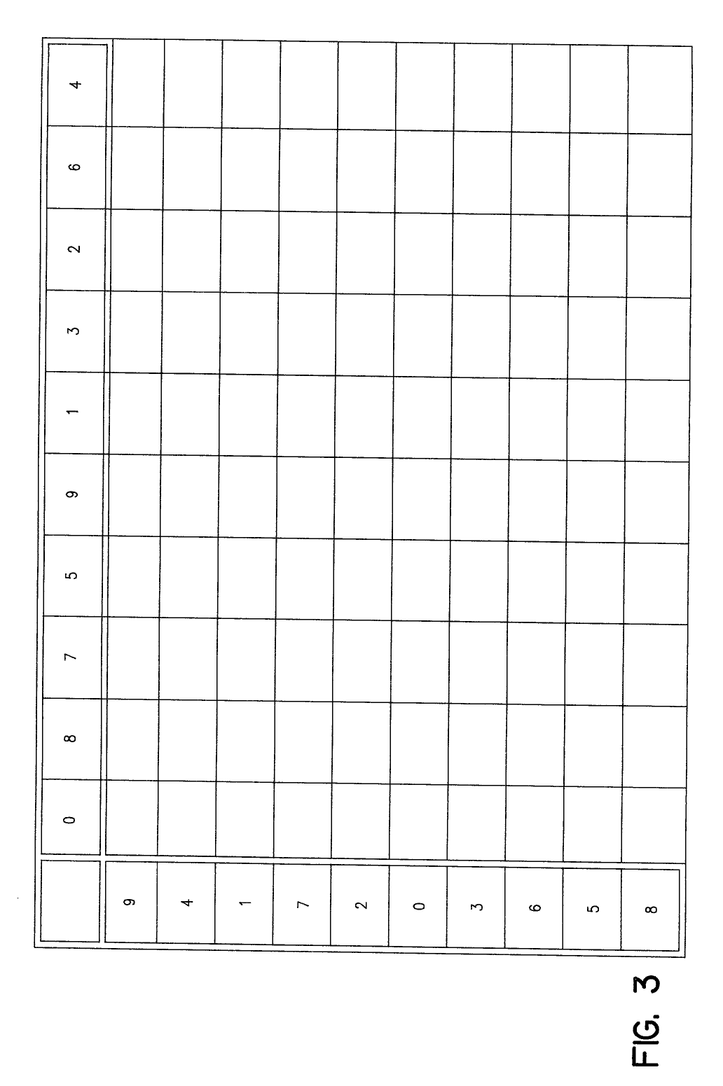

The box pool, shown in FIG. 3, also known as a grid pool, is typically used in single contest pools, for example, a championship football game, where the score typically changes regularly throughout the contest. The box pool is typically based on the score of a contest at the end of each period or quarter of play. The box involved usually comprises a grid of ten boxes by ten boxes for a total of one hundred total boxes. Random single digit numbers, zero through nine, are typically assigned to each of the ten boxes on each axis of the grid so that each of the one hundred boxes has two single digit numbers zero through nine associated with it. Each axis typically represents one team in the contest. The numbers associated with each box represent the score or the last digit of the score for the appropriate team on the given axis at the end of a given period of the game. For example, if axis-x represents team a and axis-y represents team b, and player z draws the numbers 3(x) and 7(y), then player z wins the pool, or part of it depending on the rules of that pool, if the scores of teams a and b end with the numbers 3 and 7, say 13 to 7, at the end of a given period of play. The pool administrator is provided with the options though the network interface to select the various events (half-time score, final score, number of beer commercials) which trigger the picks of the box pool.

A cumulative pool usually involves adding together a player's total number of correct picks in a number of contests over a long period of time, such as an entire football season. Whether a player's picks are correct in a cumulative pool usually depends on two things, who the winner of a particular contest is and the point spread. Typically, a winning pick in a cumulative pool involves picking the favorite team by a certain number of points, or picking the underdog to win outright or at least, in losing, to lose by less than a certain number of points. The spread in essence gives the underdog a certain number of points to begin with. The spread for a contest may be determined in a number of ways. The administrator may pick the spread when setting up the pool, by drop down menu or otherwise, it may be entered by hand by the administrator, or it may be incorporated from a real time or other sports news source. Also, the spread may be picked on a date certain and not change or it may be rolling and change as the pool develops only becoming certain on a date close to or including the date of the contest.

A suicide pool means that when a certain pick made by a player fails, the player is out of the pool. For example, an NFL® suicide pool may include a number of players who, throughout the entire season, choose weekly a single team that must win that week. If the team chosen loses, or does not cover the spread, if one is used, then that player is out of the pool for the entire year. In such a suicide pool, the only players remaining each proceeding week, if any, are those that have not lost a single pick all season.

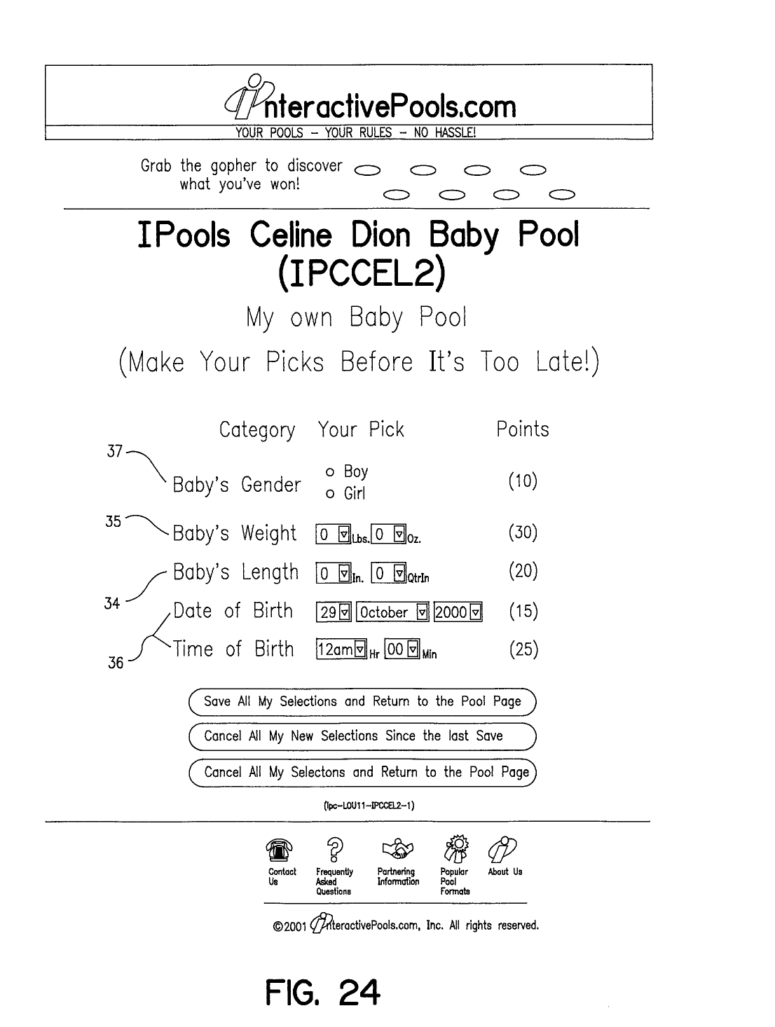

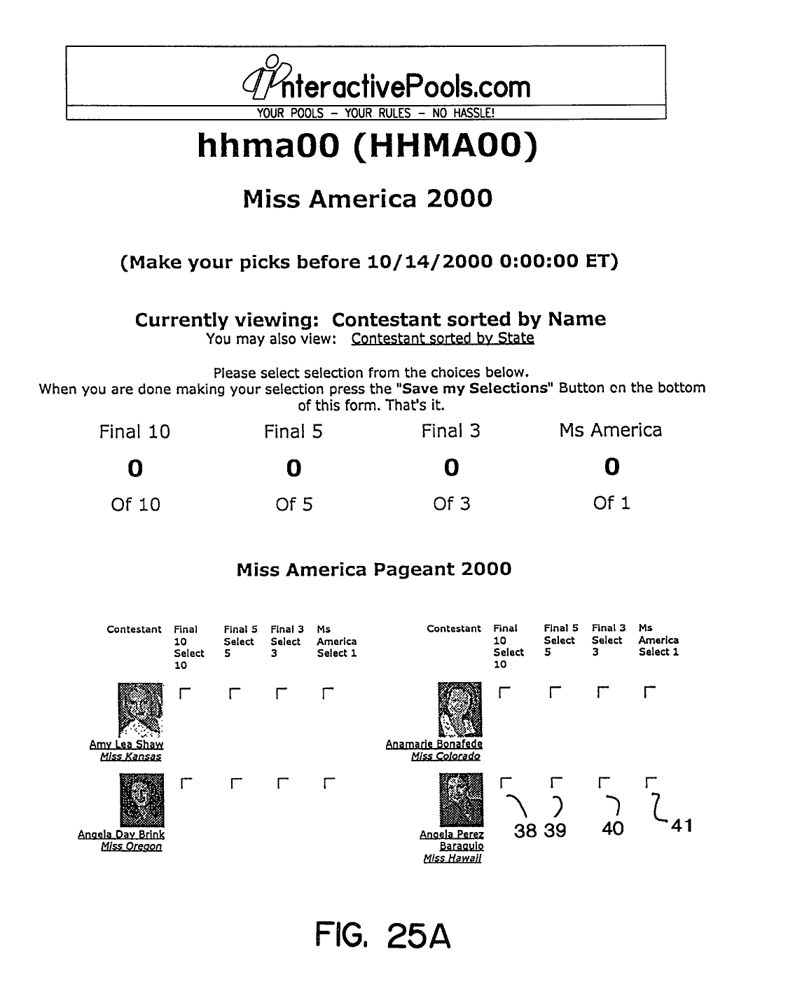

A baby pool, as shown in FIG. 24, is typically an award pool where the baby's length 34, weight 35, name, time or date of birth 36, gender 37, etc., are picked prior to birth and the player coming closet to the actual parameters wins.

The power draft pool involves handicapping teams or individuals participating in events. For example, where a certain golfer is often the favorite to win in golf tournaments, a power draft pool involving him may have him at five strokes behind the field before the event starts, such that in order for a pool player to win the pool by picking that golfer, the golfer must win by, in this case, at least six strokes. (Tiger Woods is a recent example of a golf that would likely enjoy such a “handicap.”) This concept may be adapted for any sport and the amount of any particular handicap may, as in choosing a spread, be determined by the pool administrator, may be fixed and unchangeable, may be changeable up until the date of the event or contest, or may be linked or otherwise associated with a real time or other sports news source.

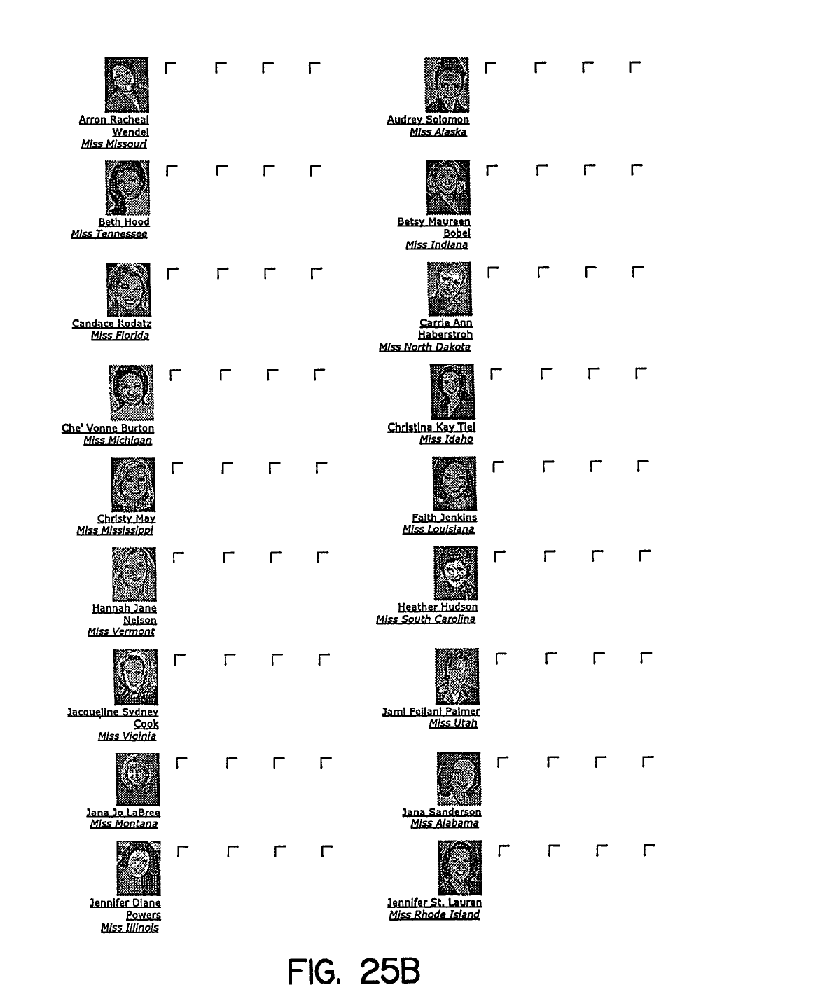

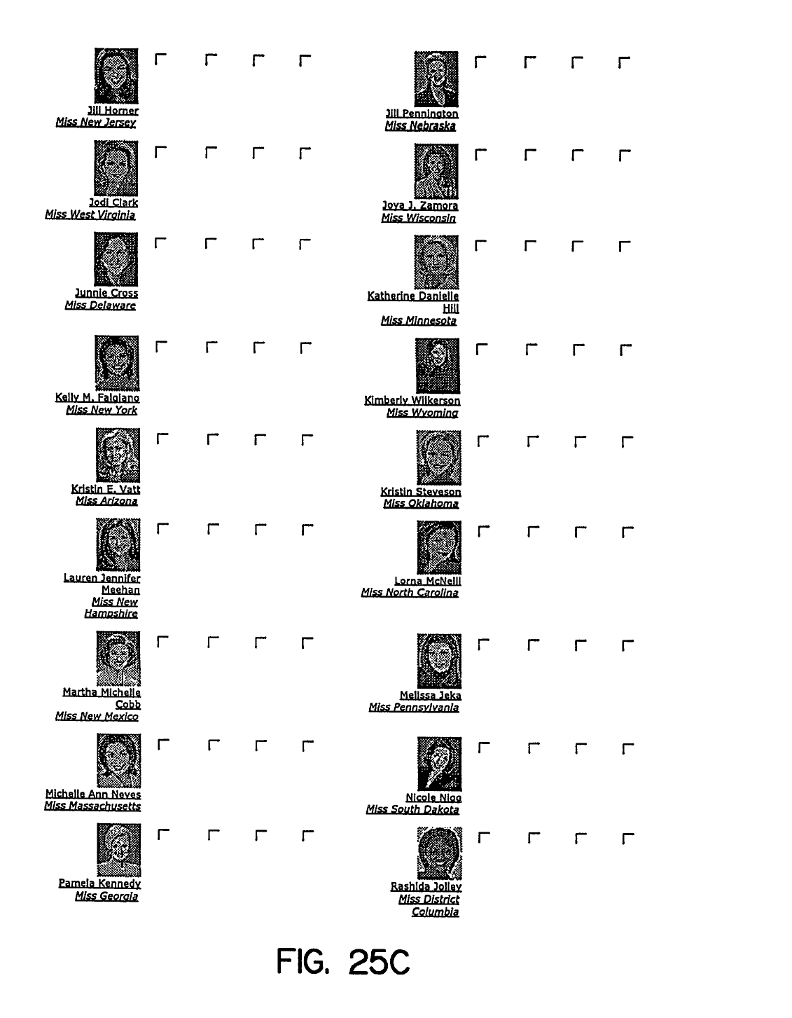

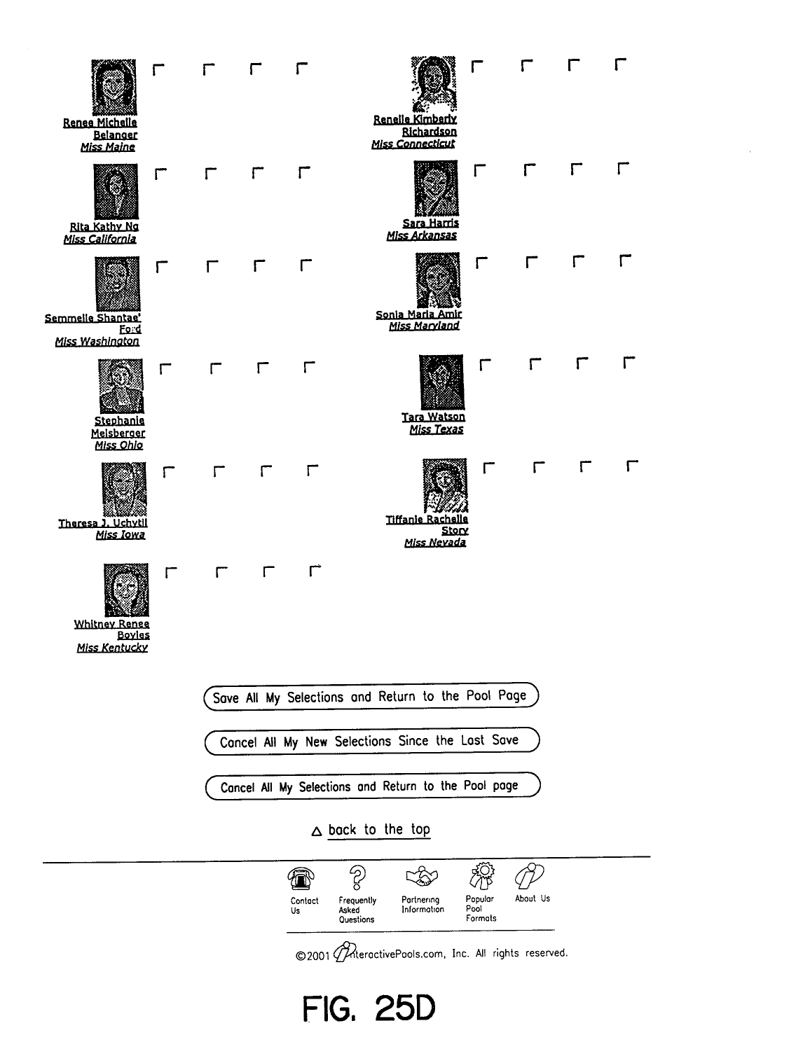

A multi-dimensional pool, as shown in FIG. 25, is a pool in which multiple picks for an outcome may be made in a particular event. For example, as shown in FIG. 25, in the Miss America Pageant, only a single contestant may win the event and become the next Miss America. However, if the administrator or client so desires, the types of picks available in a pool may include, as one dimension is shown in FIG. 25, multiple dimensions or types of picks for various stages of the events, including, as shown in FIG. 25, Final 10 38, Final 5 39, Final 3 40, and/or Final 1 41. These picks may be limited or not limited to the available amount, so that the user may be permitted only to pick ten contestants to be in the Final 10, five in the Final 5, three in the Final 3, and 1 as the winner; or the user may be permitted to pick more than or less than the available amount, so that the user may be permitted to pick, for example, fifteen contestants to be in the Final 10, and five in the Final 3, or only five of the Final 10, or only three of the Final 5, depending how the administrator or client wants to structure the pool. Another dimension of this pool may involve rating or polling on a scale, for example, a scale of one to ten, each contestant, or person, or thing in a certain stage and making that a pool parameter. Each contestant may be rated one to ten in each or any particular stage of the event, i.e., evening gown, talent, etc., such that the results in a particular stage may be used as a pool parameter. This dimension of the multiple-dimensional concept may likewise be limiting or not limiting such that users may be limited to the number of “tens” rated or “nines” rated or they not be so limited and may rate each contestant a “ten”. Balloting for the most-valuable-player MVP for a particular sport or sporting event (e.g. National League MVP, World Series MVP) are also appropriate candidates for multi-dimensional pools.

A further advantage of the multi-dimensional pools of the present invention is the number of selections that are possible are essentially limitless. For example, a multi-dimension pools can be established to allow a user to pick the top 100 songs of all time for instance or the 1000 greatest music videos ever made. Thus, a pool is established in which an essentially infinite number of selections may be made. This capability is significant because its significant flexibility to the system.

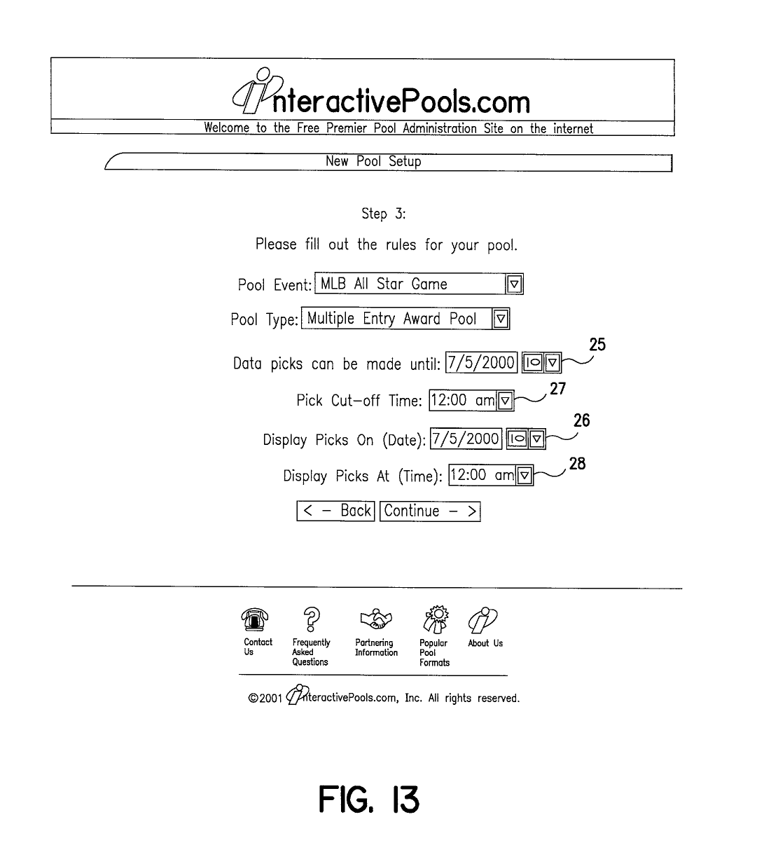

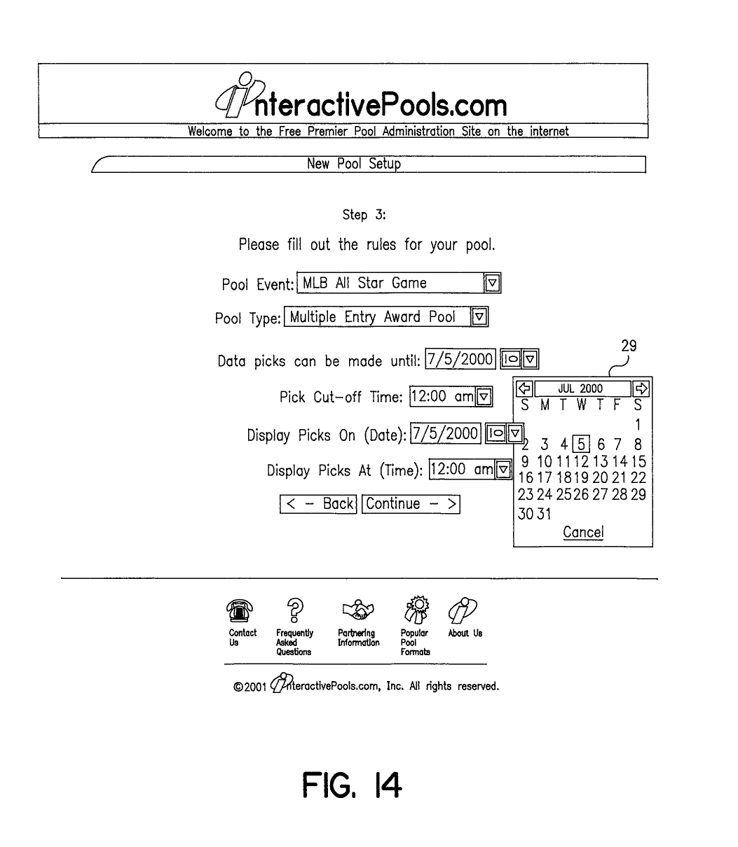

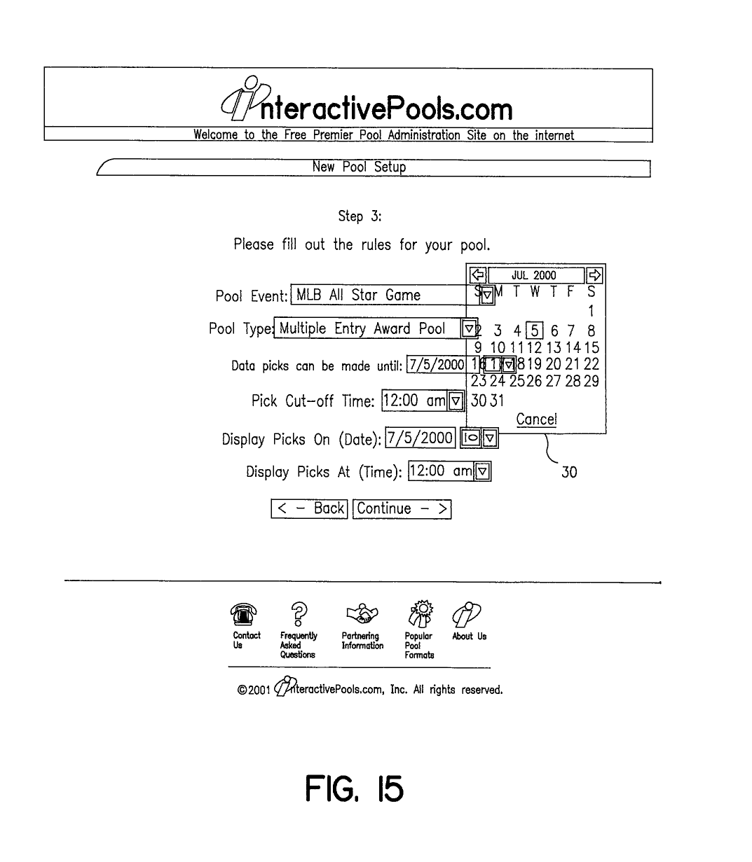

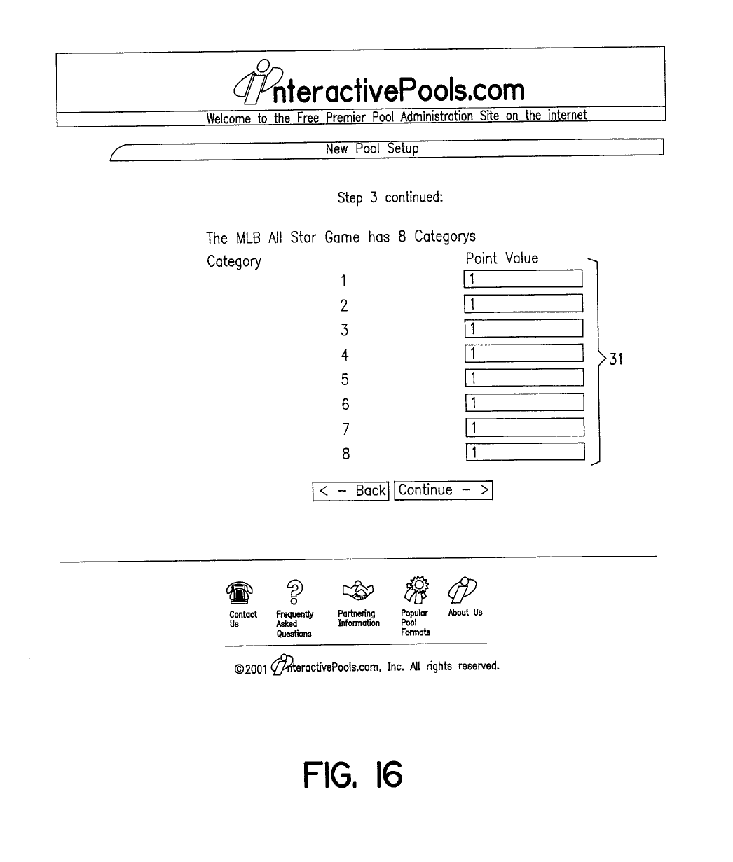

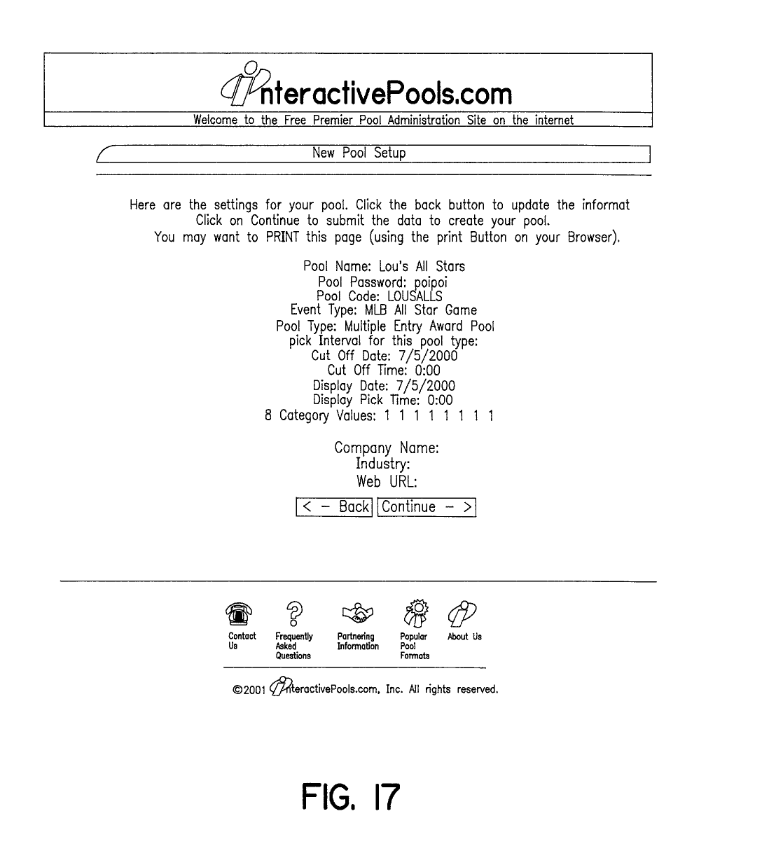

Once the Pool Event and Pool Type are determined, the administrator may continue in creating the pool by assigning cut-off and display pick days or days and times, depending on the type of pool. Cut-off days and times are an important aspect of a preferred embodiment of the present invention because they set an automatic day and/or day and time certain for a pick entry deadline which is essential for proper, efficient administration of an event pool. By using pick cut-off days and times, the pool administrator and players are assured that at a certain time on a certain date all picks will be entered and the next step in the pool may commence. Similarly, display pick dates and times are an important aspect of a preferred embodiment because they allow for the convenience of the pool administrator and players being able to view all participants' picks at a date and time certain. Pick cut-off days and times and display pick days and times are offered to the administrator in setting up a new pool in the present invention, as shown in FIG. 13, which depicts the chosen pool event and pool type and offers, by drop down menu, various pick cut-off dates 25 and times 27 and display pick dates 26 and times 28. FIGS. 14 and 15 show the drop down calendar menus offered for picking the pick cut-off date 29 and the display pick date 30.

A next step for setting forth rules in the creation of a new pool is setting the point values for any category or round in a particular event. With an event with numerous rounds or separate categories, such as a basketball tournament or award show, a pool administrator may want to assign varying point values to each separate round or category. For example, in a basketball tournament, there may be a total of five rounds, including a first round, a second round, a third round (the quarterfinals), a fourth round (the semifinals), and a fifth round (the championship game). The pool administrator may desire to assign different point values to each round, such as one point for each first round win, five points for each second round win, etc., with the final round being worth, for example, twenty-five points. In this way the pool administrator may weight, prior to the event, the later rounds where the ultimate outcomes are likely to be most uncertain. This concept may apply to a different type of pool, such as an award show pool, where, instead of rounds, there are different categories. Categories may consist of, for example, best actor, best picture, best costume, best action sequence, best set design, etc., and the pool administrator may desire to assign a greater point value to more popular categories, such as best picture or best actor, and lesser point values to less popular categories, such as best set design or best costume.

In the application service provider embodiments of the present invention, the choice and assignment of the differing point values to the different rounds or categories may be customized for the customer by the service provider. A programmer at the programming point 50 can work with the customer to chose and assign the point values for a particular pool. Alternatively, the customer can leave it for the service provider to chose and assign a default value.

The new pool setup of the present invention, as illustrated in FIG. 16, allow differing point values to different rounds or categories consistent with these concepts. The point value area 31 shows eight different categories associated with an event pool which the administrator may set according to his desires while setting up the new pool. Another context demonstrative of this concept is a certain type of baby pool, wherein certain parameters may be weighted prior to the event, i.e., the birth of the child, to account for developments relating to the birth prior to the event. For example, if, prior to birth, the sex of the baby becomes known, the administrator may alter the weight or value of the ‘guess the sex’ parameter to be very low or remove it altogether. He may then alter or not alter the value of the remaining parameters still unknown to correspond to the remaining uncertainty of each.

When the new pool setup is complete, the rules and unique identifiers for that new pool are stored in a transactional database 90 at the programmer point, which is coupled to the membership database 80 for that user. A compilation web page directs the administrator to the entire set of rules and parameters governing the new pool as entered by the administrator and also lists the unique identifiers associated with the new pool as entered by the administrator, as illustrated in FIG. 17. The invention contemplates that the administrator or programmer will be able to access the membership database to communicate to actual or potential users or members, including via e-mail, regarding a new pool setup to commence pool playing or to advertise a new pool setup to get more players. In the event the programmer or administrator knows the e-mail addresses of potential or actual users or players, an e-mail engine capability at the programming point may be utilized to inform actual or potential users or members, including via e-mail, regarding a new pool setup to commence pool playing or to advertise a new pool setup to get more players.

### Joining & Playing a Pool

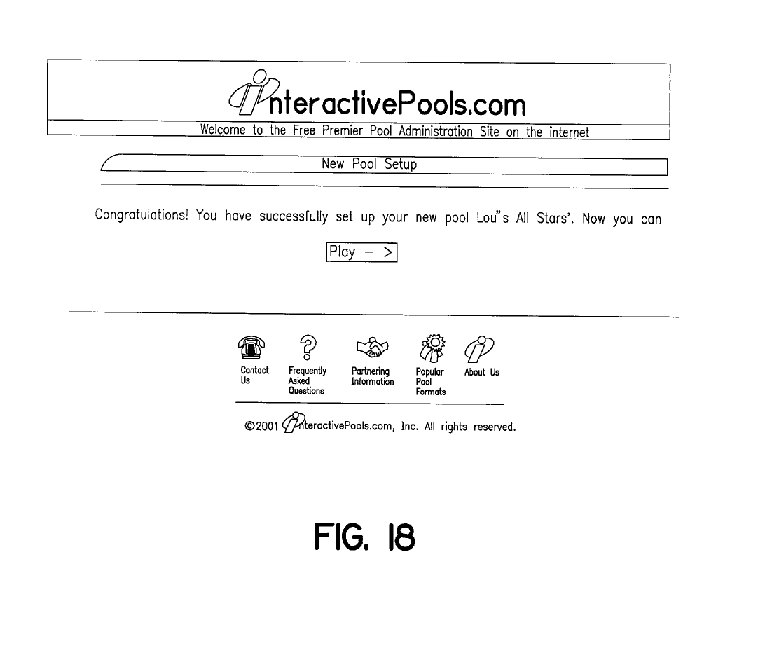

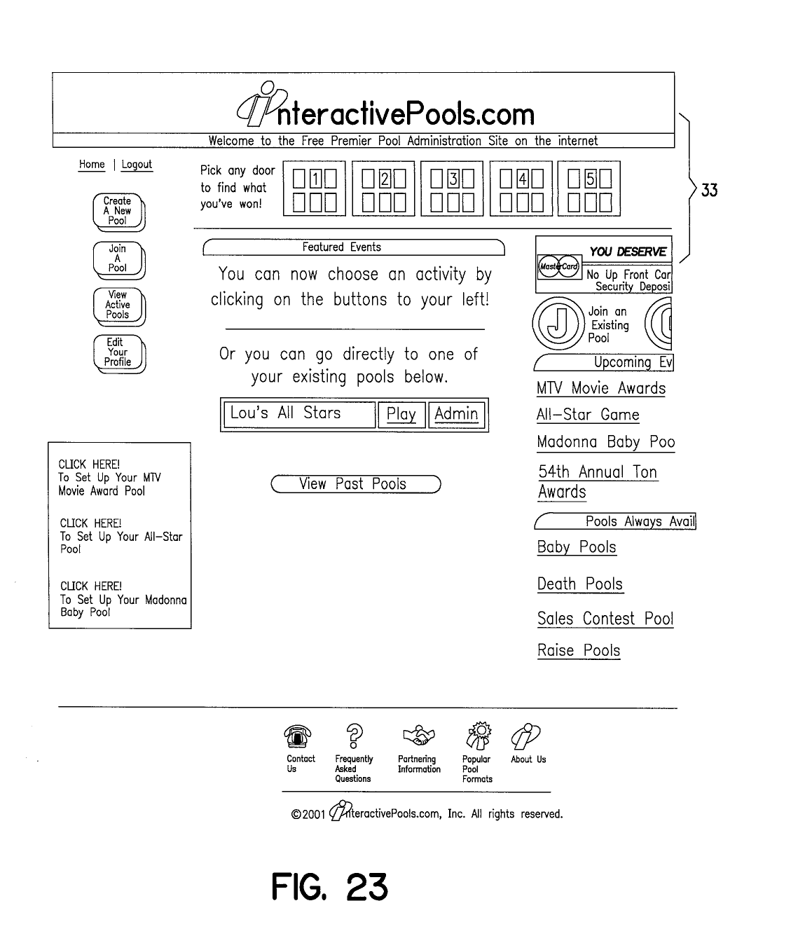

As depicted in FIG. 18, when the new pool setup is complete, the administrator is able to begin playing the new pool. When a pool administrator signs in to the web site at a time subsequent to creating a pool, an individualized web page is created enabling the administrator/player to play or administer the new pool, as illustrated in FIG. 23.

When the new pool setup is complete, other players are also able to begin play in the new pool. A new player would, after signing onto the web site as described above and illustrated in FIG. 5, click on the capital “J” in the web page illustrated in FIG. 4 an be directed to the “Join An Existing Pool” web page as illustrated in FIG. 6 where the player would enter the appropriate Pool ID 12 and Pool Password 13 supplied him by the pool administrator or other proper source.

In another aspect of the present invention, a player may join a pool that was created by a programmer or web site manager, i.e., a pre-made pool. No player or user setup is necessary in such a pool. The player merely selects a pre-made pool, such as a Madonna Baby Pool, from the main web site web page and is then linked to a pick page or individualized Pool Page or the like as described immediately below.

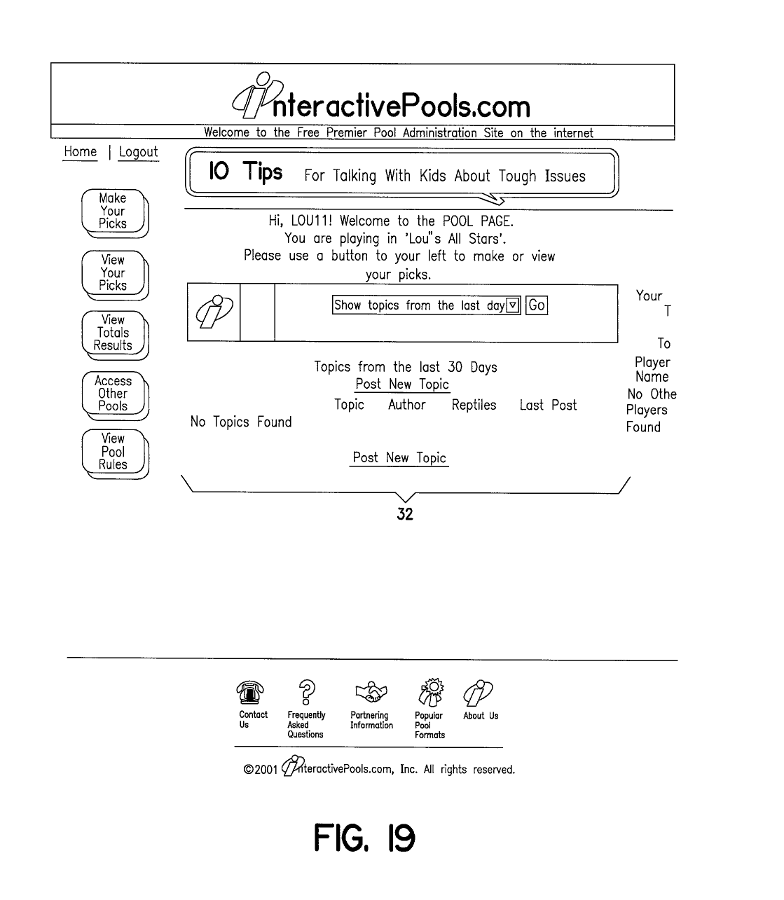

When a player joins or creates a pool, an individualized Pool Page is created, as illustrated in FIG. 19. The Pool Page offers player access to numerous web pages associated with the particular pool, including web pages that allow the player to make picks, view his picks, view total results of the pool, access other pools, and view pool rules. The Pool Page also has a topic area 32, which enables pool players to view and post topics or notes made by players of the particular pool. The Pool Page also informs the player as to how many other players are playing the particular pool.

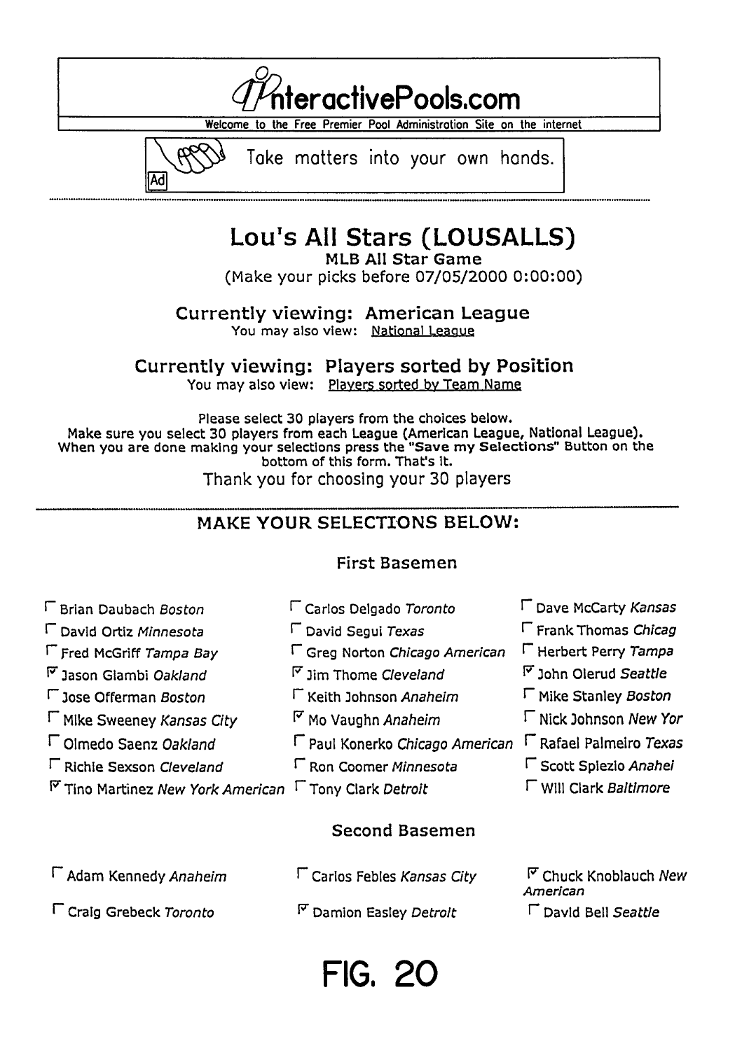

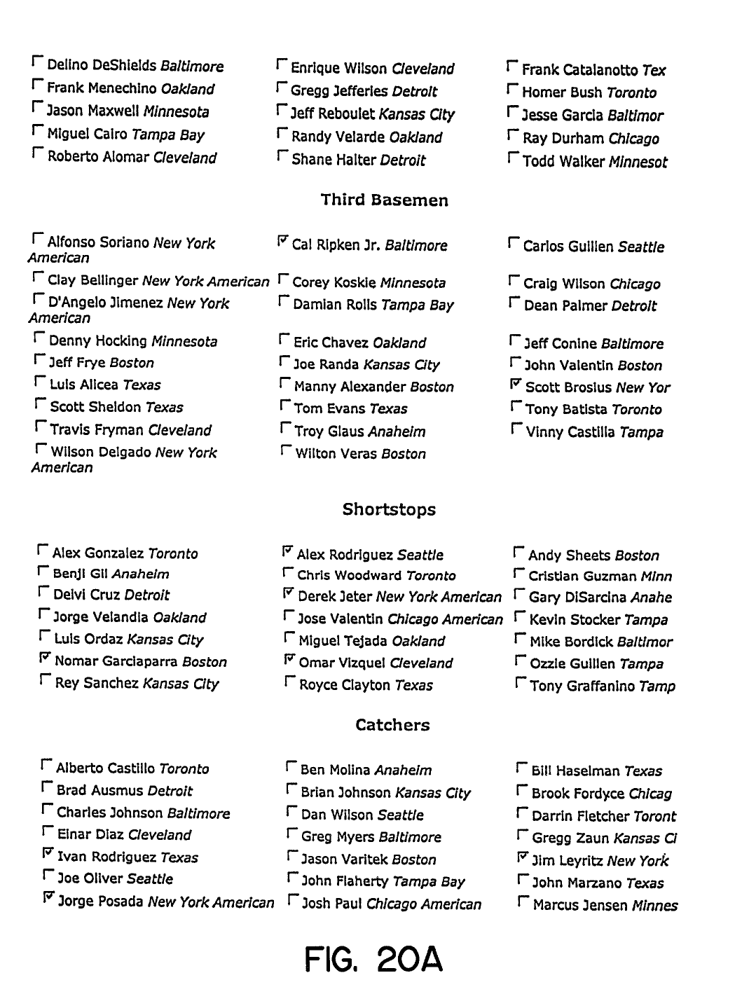

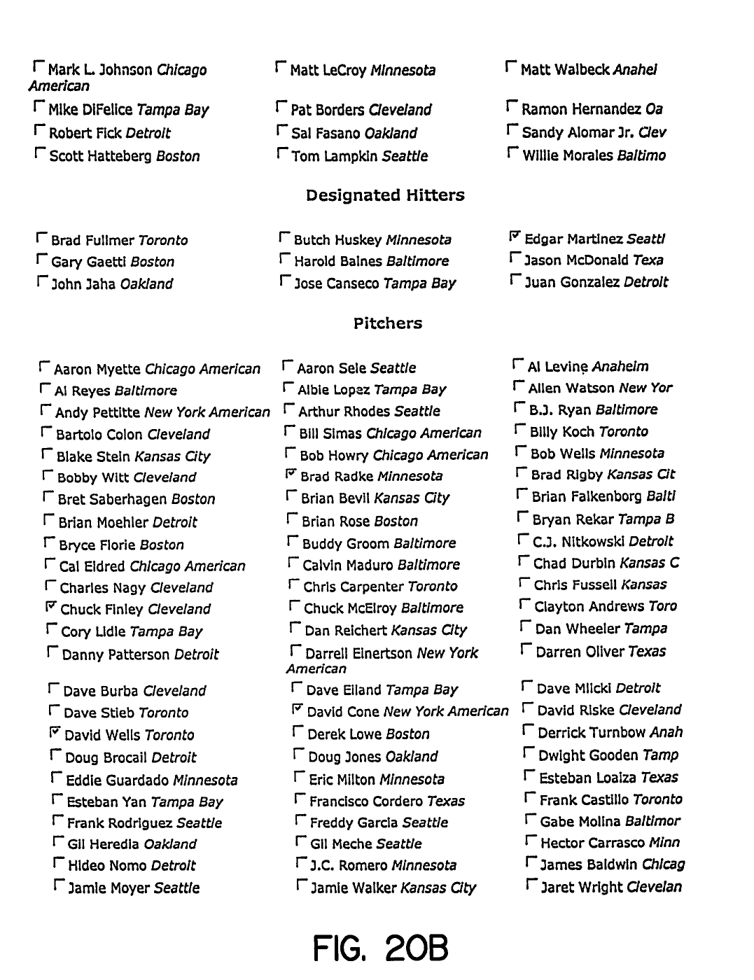

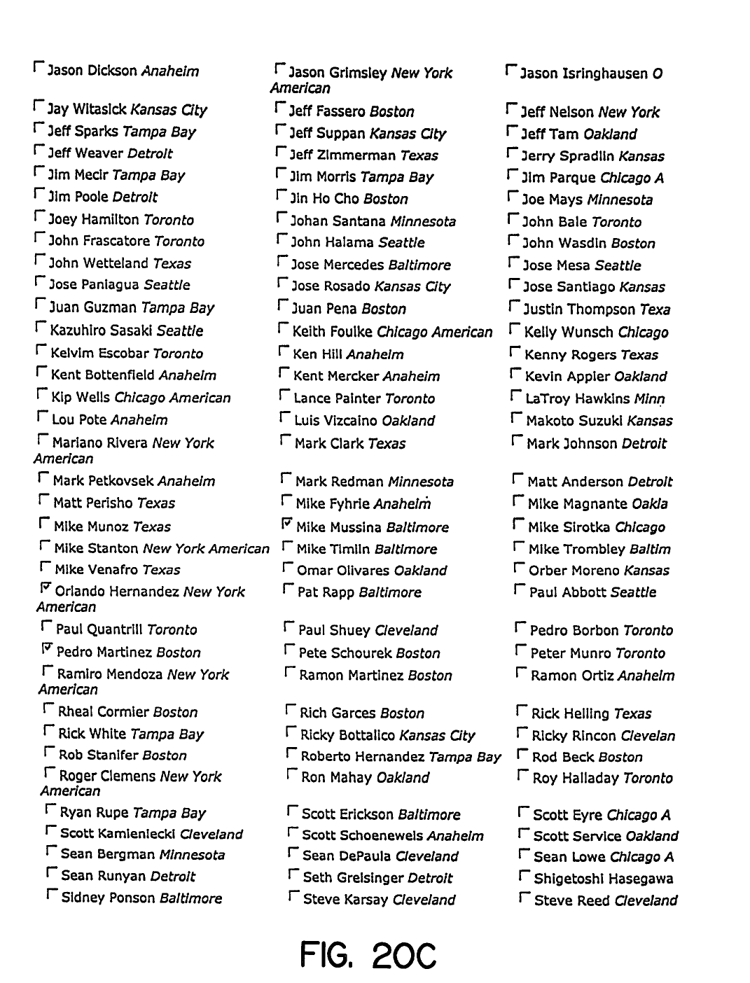

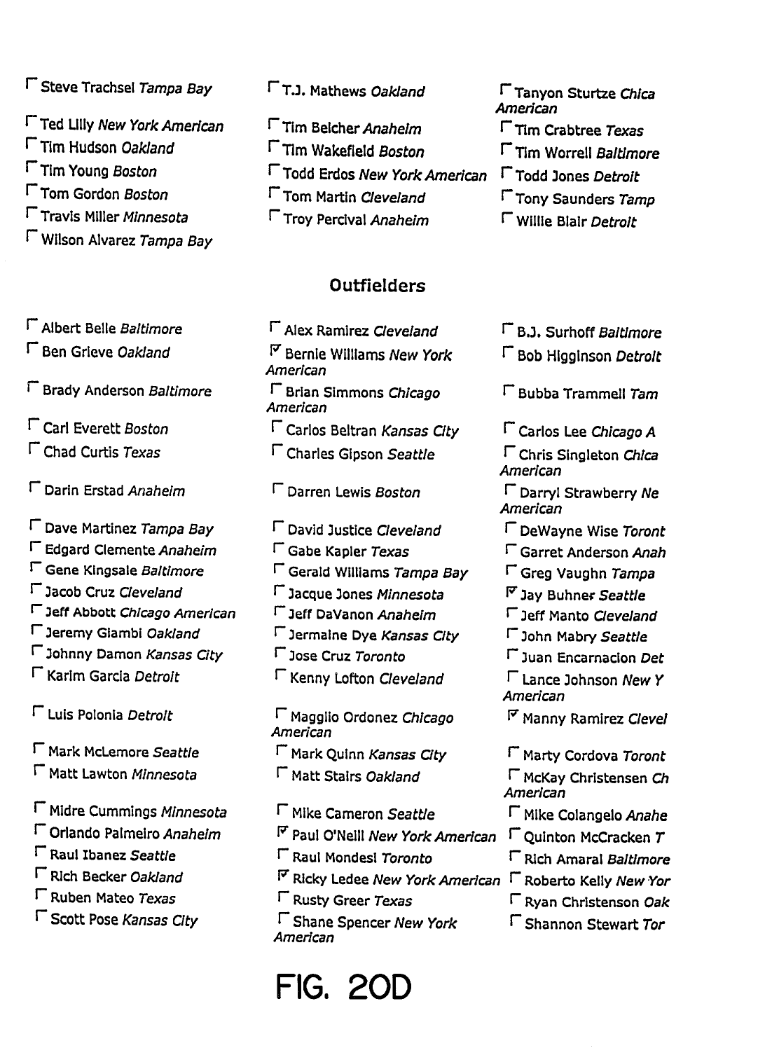

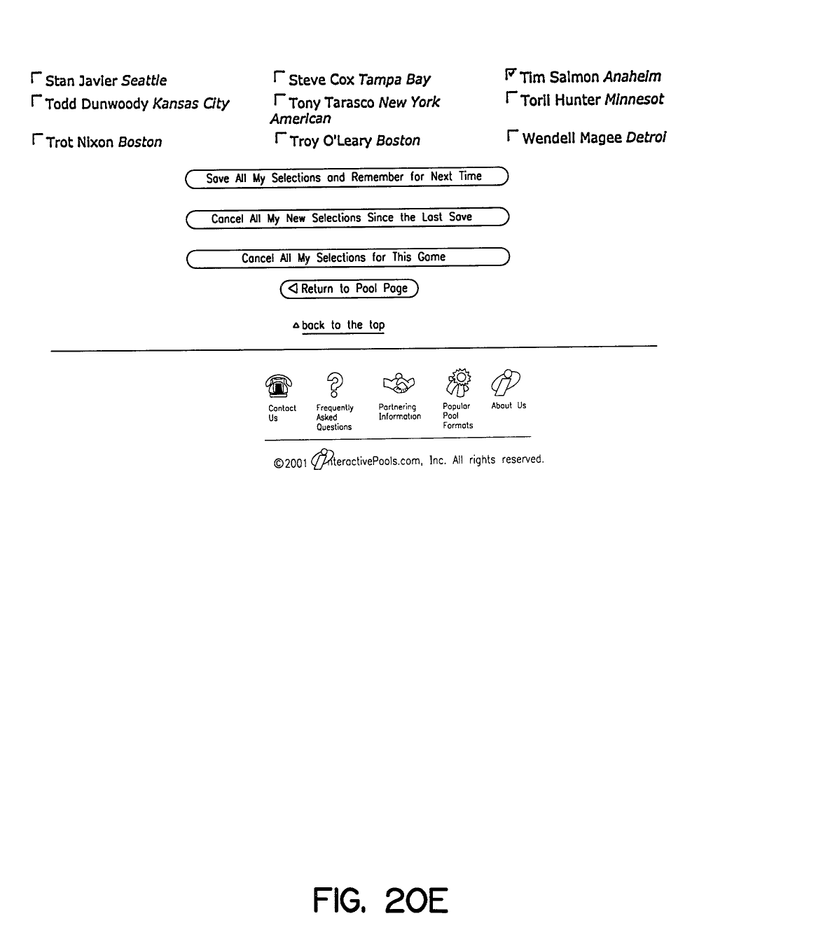

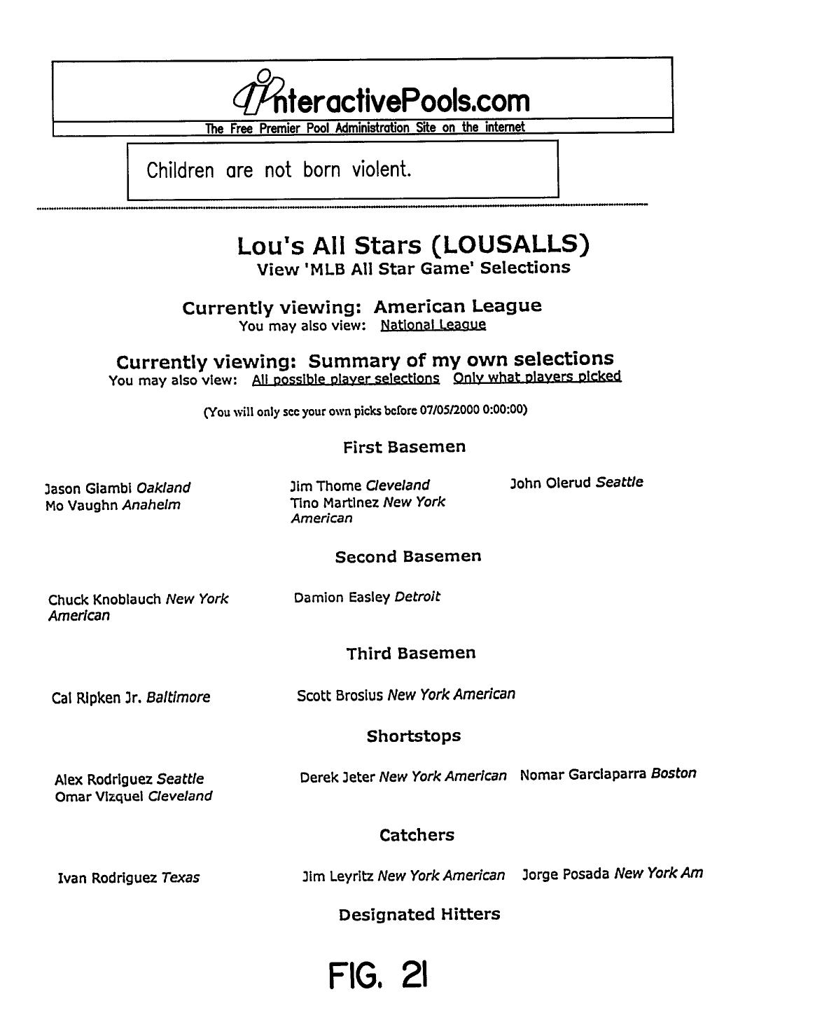

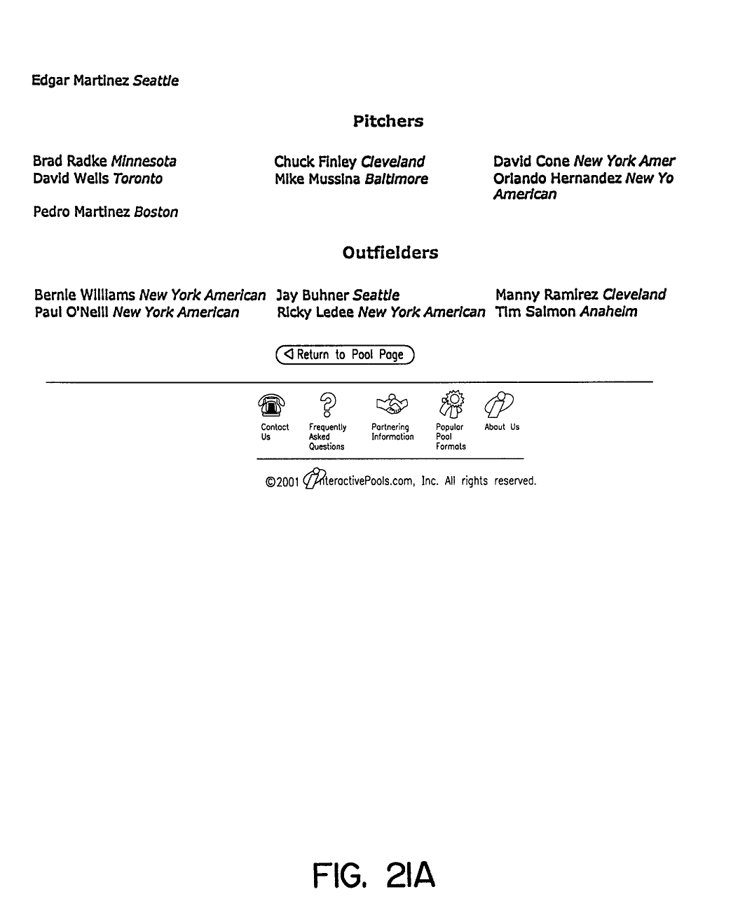

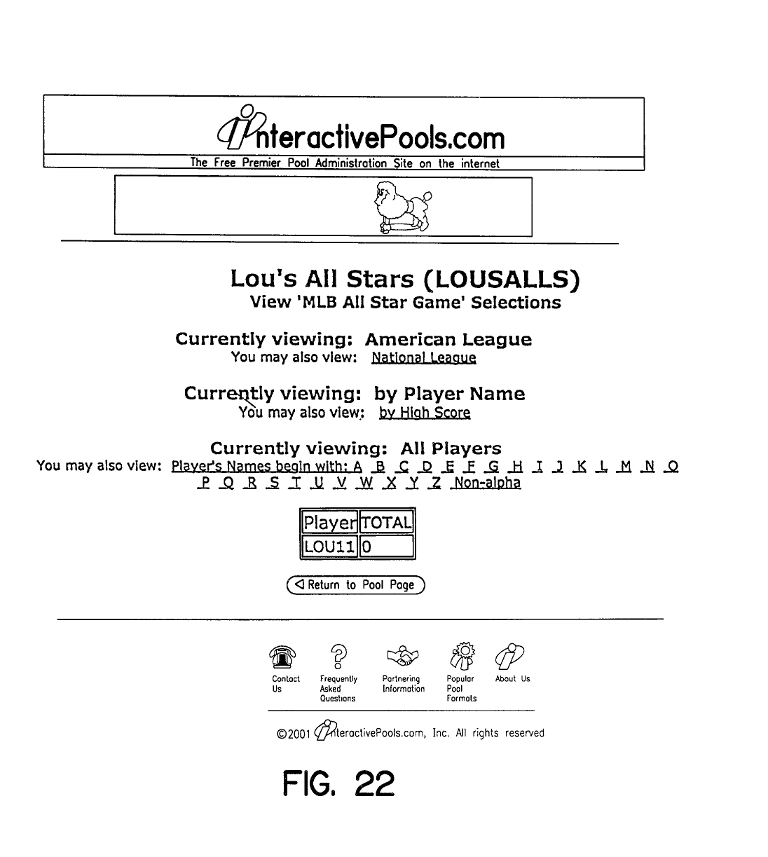

FIG. 20 illustrates a pick web page for a multiple entry award pool, which is one pool type offered in a preferred embodiment of the invention. This pick web page allows a player to make his picks for the multiple entry award pool. The player makes his picks by clicking in the boxes next to a given pick. When the player completes making his picks, the picks are saved to a transactional database 90 maintained at the programmer point and may be viewed by the player from the Pool Page, as illustrated in FIG. 19. A view picks or selections page is illustrated in FIG. 21. If the pick cut-off date and time have not passed, a player may make changes to his picks by re-entering the changed picks prior to the cut-off time.

### Viewing Pool Results

The present invention employs automated scoring, updating and display. Whenever a event result is obtained, the pool is updated to reflect the event results. Scoring algorithms in the programming point automate the scoring process. The algorithms look at the selections made by the user, the score or outcome of the event and any spread or other variable relevant to scoring. Scoring also depends upon whether a person made a selection and if the selection was timely and timely. If it is determined that a user's selection was invalid or lacking, the system looks to how the pool was established to determine how the handle the situation. The administrator is provided the opportunity when establishing the pool to select how invalid or lacking selections are to be handled. The system also has a default methodology for handling these types of selections. Typically, the administrator chooses to populate invalid or lacking selections with either the home or visiting team, or either the favorite or underdog.

After all picks have been populated and the score and applicable spread have been applied, the algorithm performs all necessary comparisons to determine the outcome of the event. The system assigns a point value for each event in the pool per round per category (as appropriate). The pool is updated. Outcomes of tie breakers are determined by the system default or how the administrator has established the pool. For example, if more than one person has more than highest point total, the administrator gets to decide the weekly tie breaker questions.

The results can be provided to each of the users via email, pager, telephony or being retrieved by calling up the pool over the internet. The present invention also allows real time updates or scoring, such as, for example, by being connected or linked to internet-based news and sports information sites and real time sources.

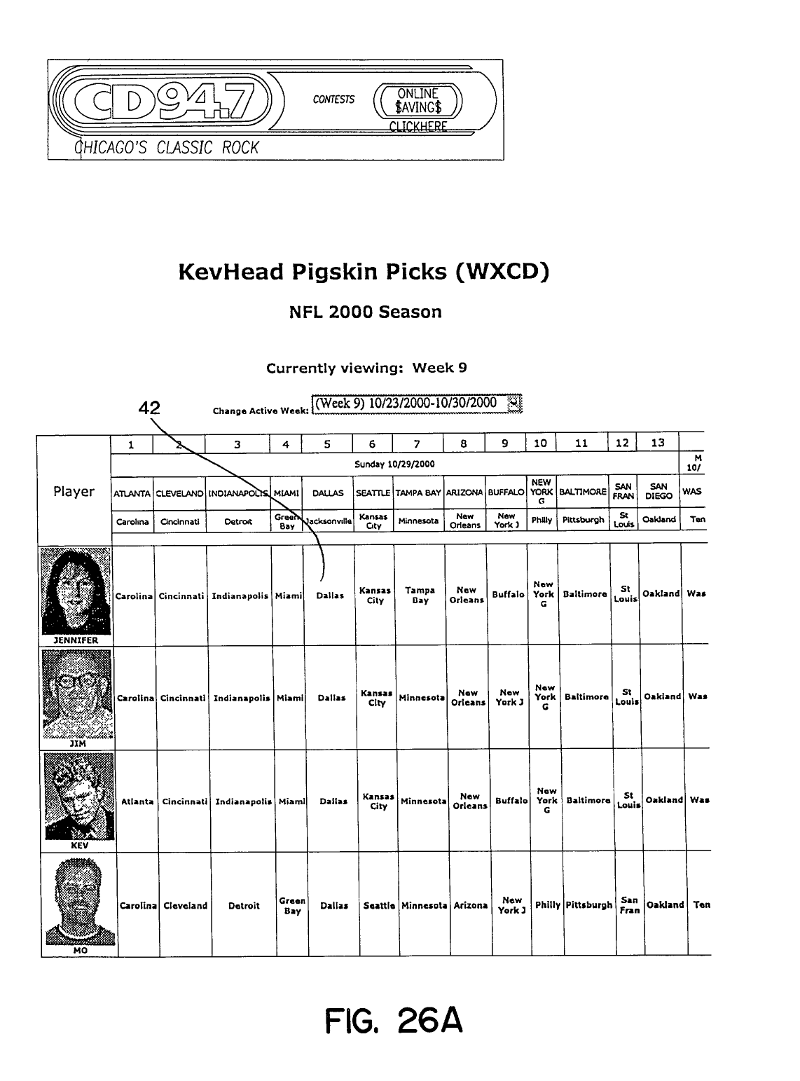

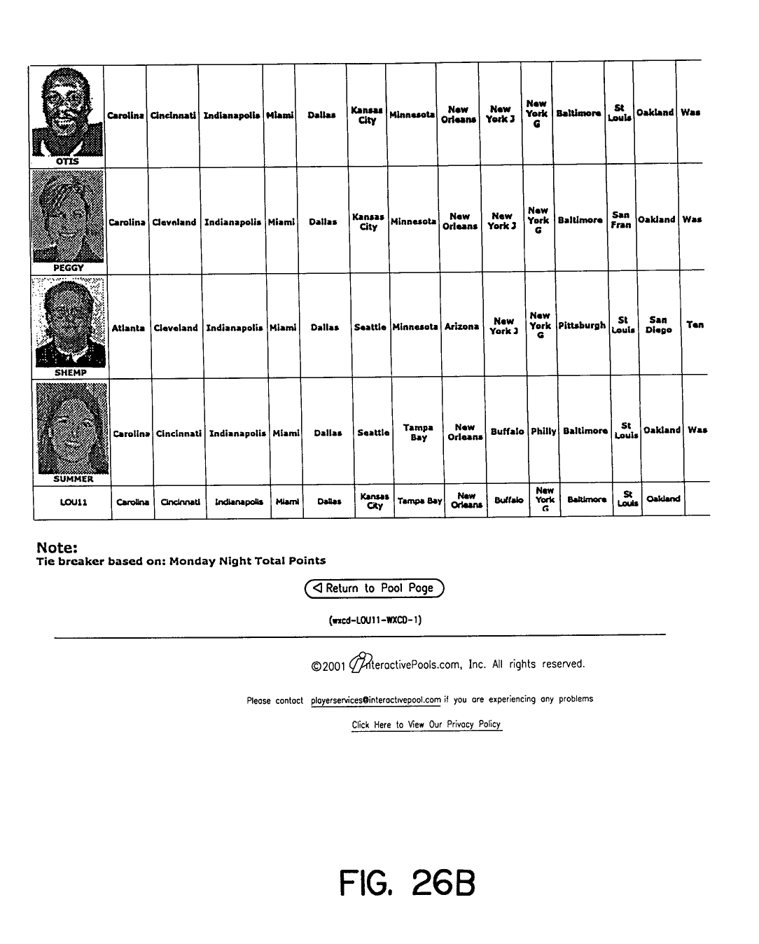

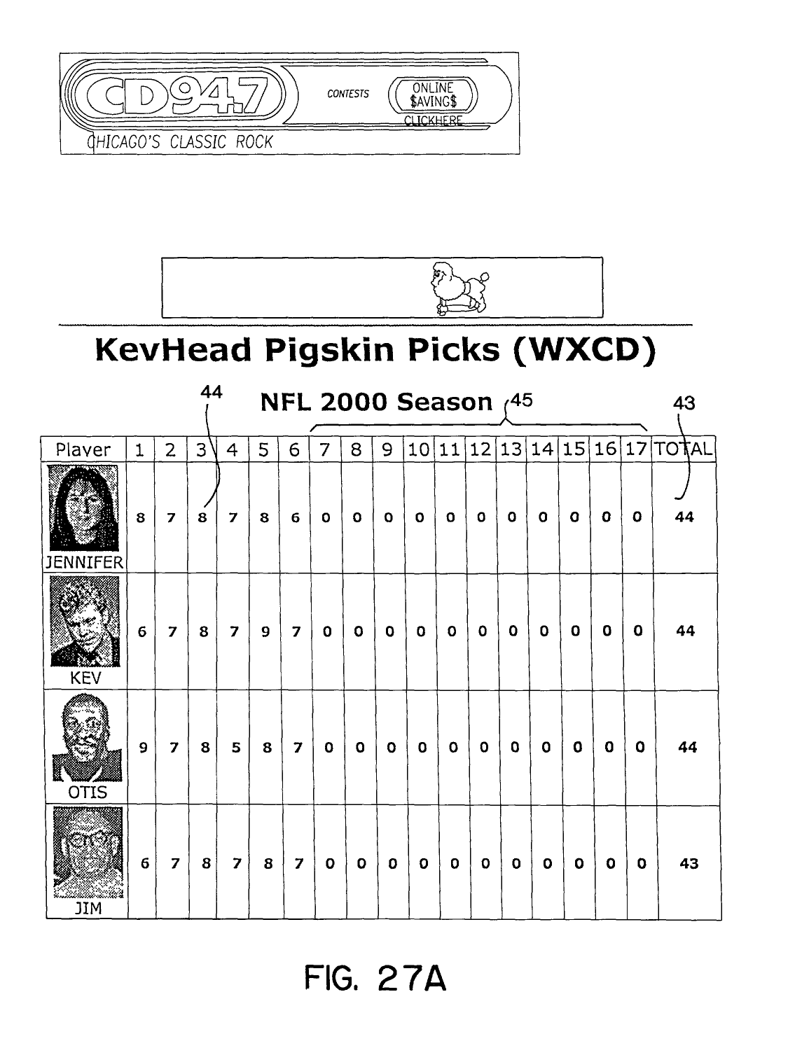

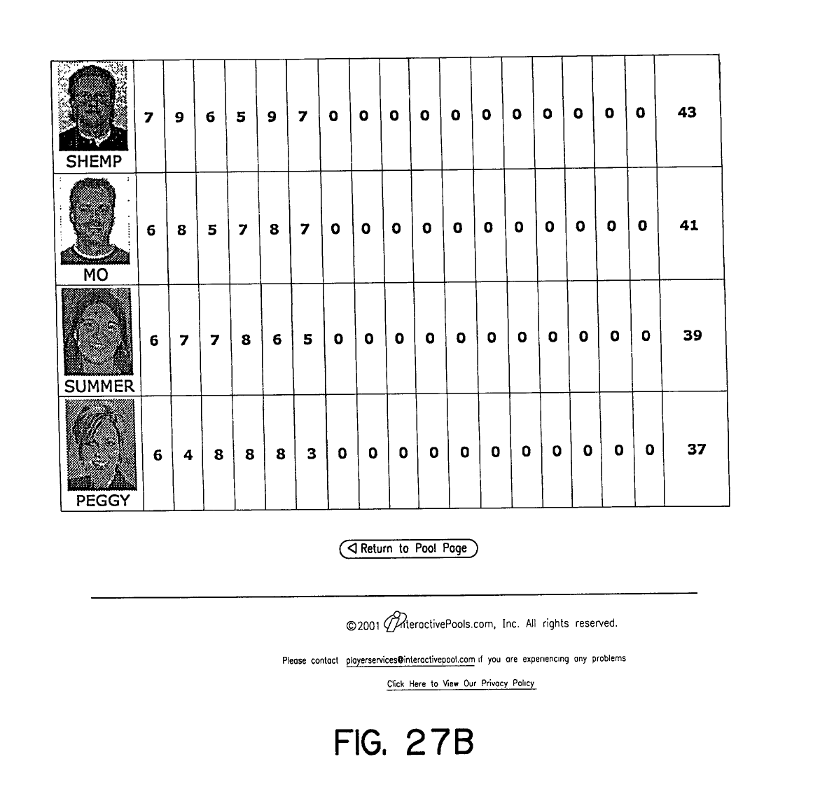

FIGS. 26 and 27 show pool results from a cumulative pool of the present invention. In FIG. 26, the results from a particular week of National Football League games is shown with the individual game 42 results shown for each pool player. The cumulative season total results 43 for this pool is shown in FIG. 27, which also shows the individual week results 44 from those weeks already decided and the amount of time, in this case weeks 45, remaining in the cumulative pool event.

### Hierarchical Questionnaire

In one embodiment of the present invention, one or more companies is able to sponsor a particular event pool. For example, Pampers®, a well-known manufacturer of diapers, may choose to sponsor exemplars of the above-identified Baby Pools. Another example would have Sports Bar within a reasonable distance from the recorded address of the user sponsor exemplars of any number of the above-identified sports related event pools. The event pool includes indication that the particular pool is being sponsored by the company.

An advantage of the present system allows the sponsor to prepare a series of questions to the user to obtain relevant marketing information. Using the diaper example above, Pampers arranges with the provider of pool services to have a series of questions asked of the user when the user seeks to use the sponsored baby pool. For example, if a user want to participate in a baby pool, the service provider is capable of querying the user whether the user has any children and, if so, what brand diapers are used. A further advantage of the present invention is that because the provider of pool services has certain information about the user in its membership database(s), it is capable of tailoring the questions to the particular user. For example, using the information stored in the membership database, if the system knows the user to be a woman, it can ask a first set of questions. Alternatively, if the user is known to be a man, it can ask a second set of question. In this way, the sponsor can obtained targeted marketing information.

The system is also capable of integrating the knowledge about the user in the membership database with the answers given in response to one or more queries to determine a different path of questioning to improve information gathering. A rule based system is employed to permit selection of interrogation path based on past responses and user information.

### Application Service Provider and Additional Options

The system and method of the present invention is contemplated for use by both individual consumers (“B2C” offerings) and businesses (“B2B” offerings). It is anticipated that each of these markets may generate substantial revenue through a multitude of channels. Two such channels are user/player biographical data collection and reporting and advertising management and administration. When an individual consumer uses the B2C offerings of the system and method of the present invention, the individual's membership information may be collected and reported under certain guidelines and advertising targeted to that individual may be developed. When a business uses the B2B offerings of the system and method of the present invention, such as in a private label capacity, the biographical and like information of each of the individuals participating in the business's pool or game may be similarly collected and reported and even used to promote the B2C offerings. Also, in the B2B offering, advertising may be targeted for the individual or it may be developed according to the business's relations or other desires.

As previously described, systems and methods of the present invention may advantageously be provided to users via a plurality of corporate customers though private labeling arrangements. For example, one or more radio stations may engage the services of the provider of the internet-based system for administering pools to set up one or more pools for the radio stations listeners. Each corporate customer (e.g., radio station) likely has its own web sites which may be visited by the radio stations listeners. A corporate customer desirous of establishing a promotional pool to attract listeners to the web site can engage the service provider to establish a pool. The corporate customer works with the service provider to customize one or more pools specifically for the customer. The service provider is provided appropriate banner ads and links, logos, frames and other information which allows the service provider to build a user interface customized for the customer. The corporate customer also works with the service provider to determine what type of membership information should be sought at sign in.

The corporate customer adds a selectable customized button on its web page. If more than one poll is established, a plurality of selectable buttons are added. When selected by a user (in the example, a radio listener), a frame appears in the web site which is a private label pool which has been customized for the corporate customer. By selecting the button, a URL link is established with the service provider. The service provider has established by working with the corporate customer a customized a pool. Included in the customized pool are banners and logos which have been stored on the service providers databases. The user is presented with the pool as though it has been generated and managed by the corporate customer. In this private labeling arrangement, the presence of the service provider in the administration of the pool should be generally invisible.

In addition to the private label capabilities, a further B2B application of the present invention includes using eOSKS as a distribution mechanism. These eOSKS provide public access to the internet specifically for use as an internet point in accordance with present invention and may be coordinated to coincide with a business's promotional events or other event of interest to the business.

The biographical information collected by the system and method of the present invention may also be used for other business applications, such as polling or opinion gathering.

FIG. 23 illustrates an aspect of the present invention that is useful in managing and administering advertising. FIG. 23 depicts a multi-hierarchical structure of a customized screen. This structure is useful in managing and administering advertising on a web site. Once a player signs up to the web site, he is assigned an individualized or customized web page, called an Active Pools Page, shown in FIG. 23. Each player's Active Pools is multi-hierarchical: it includes numerous cells or areas of the web page which offer the player various options as to how to proceed, including playing or creating a pool or visiting advertisers' or sponsors' web sites 33. Each cell may further offer various options with regard to the topic included in that cell, such as a sports news cell offering links to various real time sports news web sites or a sponsor's cell offering links to various purchasing or browsing web sites, making the web page multi-hierarchical. The web site may include means for keeping track of the cells used and/or the links connected to by any given player or a method of detecting mouse clicks on a particular cell, link, or area of the web site and may use such information for, among other things, targeted advertising.

Targeted advertising comprises a person or entity that is able to at least partially control the type and content of advertisements and other non-pool specific web page cell and structure information included in each web page comprising the system of the present invention. Targeted advertising may be achieved in a number of ways within the system of the present invention. A first way is described above, where means of keeping track of a player's clicks on the cells of the web site are incorporated into the web site. A programmer or sponsor may use the collected information to control and include similar or related advertising in the web pages accessible to the specific user. A second way of achieving targeted advertising within the web site of the invention is for a programmer, advertiser, or sponsor to utilize the user demographic information entered by users in signing up to the web site to advertise or offer particular products and/or services to users. This may be achieved generally in the web site, using group demographics to advertise in the generalized web pages of the web site, such as the web site home page shown in FIG. 4, or on an individualized basis using demographic information from individuals to incorporate targeted advertising into individual players' Pool Pages and Active Pool Pages, such as that shown in FIGS. 19 & 23. A third way targeted advertising may be utilized in the web site of the present invention is to target advertising based on pool event. A pool based on a sporting event may have advertisements incorporated into its various web pages geared toward that sport and its related endeavors, products, and services; whereas an award pool may have advertisements incorporated into its web pages geared toward the products and services related to the award ceremony. For example, a programmer or sponsor of a web site of the present invention may incorporate golf and golf related advertisements, such a golf clubs or golf lessons for sale, in the web pages associated with a golf tournament pool created and maintained using the present invention. In the same way, music compact disc, stereo equipment, or motion picture advertisements may be incorporated into music and/or movie award pools created and maintained using the present invention.

The content and type of advertising may also be controlled by a user or player. A user's Pool Page, Active Pools Page, or other customized web page associated with a user may offer the user a choice as to the type and content of advertisements in the web pages customized for that player/user. For example, a player customized web page may offer a player a myriad of advertisement schemes from which the player may choose, for that visit to the web page only or for permanent inclusion in the player's web pages, to take advantage of Some schemes include products-only, services-only, travel related-only, products and services, sport specific, or a combination of these. In the alternative, a player may choose to have no advertising incorporated or introduced to his customized web pages. In one embodiment, the player may be offered the option of accessing a customizable screen or web page of non-advertisement information. The programmer may, but not must, require that this no advertisement option be a pay-only option where the player is required to pay a fee in order to avoid all advertising while visiting the web site or while visiting his customized web pages within the web site. The non-advertisement information accessible from these web pages comprise similar non-advertisement information that may be incorporated into advertisement included web pages, and include, but is not limited to, news, sports news, travel, weather, chat or topic, and pool information.

While the invention has been described with reference to certain preferred embodiments, these embodiments have been presented by way of example only, and not to limit the scope of the invention. Accordingly, the scope of the invention should be defined only in accordance with the claims that follow.

What is claimed is:

1. A method for establishing an event pool, the method comprising the steps of:
receiving a communication over a network from a network user desiring to create an event pool;
receiving a communication over a network from the network user a selection of at least one event pool;
establishing an identifier for the selected event pool; and
recording in a storage medium a data structure corresponding to the selected event pool, the data record identified by the identifier.

2. A method as in claim 1, further comprising the step of offering to other network users the opportunity to participate in the established event pool.

3. A method as in claim 1, wherein the establishing an identifier step includes soliciting from the network user a name to be used to identify the selected pool.

4. A method as in claim 3, wherein other network users are able to participate in the event pool by transmitting the name selected by the network user over the network.

5. A method as in claim 1, further comprising the step of offering to the network user over the network a plurality of different parameters or options for the selected event pool from which to select.

6. A method as in claim 5, further comprising the step of receiving a communication over the network from the network user corresponding to the selection of at least one of the different parameters or options for the selected event pool.

7. A method as in claim 6, further comprising the step of recording in the storage medium a record of the selection of at least one of the different parameters or options for the selected event pool.

8. A method as in claim 7, further comprising the step of establishing, ordering, and retrieving designated parameters from the record of the selection of parameters or options for the selected pool event.

9. A method of providing an event pool having a plurality of possible picks for participation over a network by a plurality of network users, the method comprising the steps of:
establishing in a storage medium a data structure corresponding to an event pool;
offering over a network to a plurality of network users the opportunity to participate in the event pool;
receiving from a network user a request to participated in the event pool;
soliciting from the network user inputs corresponding to a selection of one or more picks in the event pool;
recording in a storage medium the one or more picks made by the network user; and
upon completion of at least a portion of the events corresponding to the event pool; determining whether the one or more picks made by the network user comprise a successful selection.

10. A method as in claim 9, further comprising the step of retrieving a weighted ordering of inputs corresponding to a selection of one or more picks in the pool event from the record in the storage medium.

11. A method as in claim 9, wherein the opportunity to participate in the event pool is offered by a server maintained by the programming point.

12. A method as in claim 9, wherein the opportunity to participate in the event pool is offered by a server maintained by a third-party in a contractual arrangement with the programming point.

13. A method as in claim 12, wherein upon receiving from a network user a request to participate in the event pool by the third-party, the network user is linked to a network interface maintained by the programming point.

14. A method as in claim 9, further comprising transmitting a communication to a network user an indication whether the one or more picks made by the network user comprise a successful selection.

15. A method as in claim 14, wherein the communication comprises an email.

16. A method as in claim 14, wherein the communication comprises a wireless message.

17. A method as in claim 14, wherein the communication comprises a fax.

18. A system for providing an event pool having a plurality of possible picks for participation over a network by a plurality of network users, the method comprising the steps of:
a storage medium for storing a data structure corresponding to an event pool;
a network over which an opportunity to participate in the event pool is provided to a plurality of network users;
a server for receiving from a network user a request to participated in the event pool;
a server for soliciting from the network user inputs corresponding to a selection of one or more picks in the event pool;
the storage medium recording the one or more picks made by the network user; and
a processor for, upon completion of at least a portion of the events corresponding to the event pool, determining whether the one or more picks made by the network user comprise a successful selection.

19. A system as in claim 18, further comprising a link to a third party, the link allowing the third party to offer the opportunity to participate in the event pool.

20. A system as in claim 18, further a router for transmitting a communication to a network user an indication whether the one or more picks made by the network user comprise a successful selection.

21. A method as in claim 20, wherein the communication comprises an email.

22. A method as in claim 20, wherein the communication comprises a wireless message.

23. A method as in claim 20, wherein the communication comprises a fax.

24. A method of providing an event pool over a network to a plurality of network users, the method comprising the steps of:
establishing by a network-enabled entity one or more pool services with a provider of event pool services;
maintaining by the network-enabled entity one or more servers capable of providing a network based user interface to a network user;
providing by the network-enabled entity to a network user over the network-based user interface the opportunity to participate in one or more of the event pool services established by the network-enabled entity; and
directing the network user to the event pool service provider to allow the network user to participate in the one or more of the event pool services.

25. A method as in claim 24, wherein the event pool services provided to the network user identifies the network-enabled entity.

26. A method as in claim 24, wherein the event pool services provided to the network user does not identify the event pool service provider.

27. A method as in claim 24, wherein the establishing step comprises determining a plurality of inquiries to be made of a network user desiring to participate in the one or more of the event pool services.
